(19) United States
(12) Patent Application Publication
(10) Pub. No.: US 2011/0313781 A1
(43) Pub. Date: Dec. 22, 2011

(54) SYSTEM AND METHODS FOR CREATION AND MANAGEMENT OF AWARD-BASED CROSS PROMOTIONS

(76) Inventor: Tsz-Tak Daniel Ho, Palo Alto, CA (US)

(21) Appl. No.: 13/163,733

(22) Filed: Jun. 20, 2011

Related U.S. Application Data
(60) Provisional application No. 61/356,988, filed on Jun. 21, 2010.

(51) Int. Cl. G06Q 10/00; G06Q 30/00

(52) U.S. Cl. 705/1.1

(57) ABSTRACT

A system and related methods for creating and managing award-based cross promotions (ABCP) online are disclosed. An ABCP management system can allow sponsor entities (e.g. merchants) or an ABCP campaign organizer to create and specify details of a particular ABCP campaign, which is designed to be jointly funded by multiple sponsor entities interested in the particular ABCP campaign. The novel concept of joint-funded ABCP campaign via an online ABCP management system provides an advantage of creating a larger award for a selected winner from a pool of entrants to the ABCP campaign. The participation of a pool of sponsors allows each sponsor to leverage from a wider marketing reach of the pool, which creates a greater marketing buzz. Furthermore, the larger award in the joint-funded ABCP campaign reduces financial burdens of advertising/promotion campaigns per sponsor entity while attracting more potential entrants to the particular ABCP campaign.

### FIELD OF THE INVENTION

The present invention generally relates to joint business or event promotions by multiple participants. More specifically, the present invention relates to a system and methods for creation and management of award-based cross promotions (also defined herein in acronym as “ABCP”) and matching schemes for multiple participants (e.g. sponsor entities, organizations, and etc.) in a particular award-based cross promotion.

### BACKGROUND OF THE INVENTION

Business entities and organizations often promote themselves through advertising their services and products. An online and/or offline advertising strategy typically features branding images, or coupons which give discount to customers, in order to provide sufficient motivations to the customers to use products or services offered by a particular sponsor (e.g. business) entity. Typically, each sponsor entity pays for the costs of the marketing and advertising, hoping that such discrete advertising efforts will increase business awareness and increase sales for its services or products.

Business entities also promote themselves through a variety of award-based marketing strategies for their potential customers. For example, a sponsor entity (e.g. a merchant) may give out awards in cash or items such as a flat screen TV in a contest or a sweepstake for potential customers. At the end of a contest/sweepstake promotion period for a particular marketing campaign, one or more winners for the contest or the sweepstake will be determined according to contest/sweepstake rules. A sponsor (e.g. a business) entity engaged in a sweepstake or contest-based marketing campaign aspires to achieve higher brand awareness and increased sales. However, the value of an award in a contest or a sweepstake is typically limited by the budget of a sponsor entity (e.g. a merchant), which curbs potential customer interests in participating in the contest or the sweepstake offered by the sponsor entity.

Businesses can also form alliances or “pools” to promote their services or products together using cross-promotion (alternatively called “joint promotion”, “joint marketing”, or “joint advertising”) methods. In a typical cross promotion campaign, business entities (a type of “sponsor entities” in context of the Specifications) participating in a particular advertising alliance jointly promote all participants' services and products. A general objective in a cross promotion is to broaden each sponsor entity's reach to other business entities' customer base. If a cross promotion campaign is executed wisely, all businesses within the alliance will mutually benefit, as they have access to new channels and potential customers for advertising while sharing the costs of advertising among participating business entities.

An example of a simple cross promotion for two merchants (i.e. a merchant is a type of a “sponsor entity” in context of the Specifications) is putting each other's posters or promotional material in their stores, which allows customers of both merchants to be aware of the other merchant. They can also issue joint coupons, which can be used in both merchants for product and/or service discounts, thus allowing customers who are using joint coupons to be aware of both merchants.

An award-based marketing campaign and cross promotion methods described above do not have to be mutually exclusive, and an award-based cross promotion method (ABCP) combines the two and allows businesses to complement their promotion efforts and entice customers with an award which cannot be afforded by a budget of a single sponsor entity. In this award-based cross promotion method, merchants will join forces to offer a contest or a sweepstake, jointly formulate a budget for award(s), and promote to their existing and potential customer base. The ABCP strategy enables a contest or a sweepstake-related award to have a much higher value since the total award amount or award products can be scaled up by the number of participating merchants, which in turn creates a much bigger incentive for potential customers to participate in a contest or a sweepstake campaign.

An example of this award-based cross promotion method is having different merchants to give out prizes to a winner selected from customers who shopped with them within a certain period. A potential rule for awarding the prize may allow a person who shops the highest amount of merchandize to have the highest probability of becoming a winner of a contest or a sweepstake. There may be many variations of the rules for selecting the winner. For example, to qualify for winning, one may have to shop with all participating merchants, whether they are online (e.g. online retailers) or offline merchants (e.g. restaurants). Furthermore, each merchant purchase may have to be higher than a certain monetary value to satisfy a minimum requirement for an entrant (e.g. a customer) participation in a contest or a sweepstake. There are many ways to decide a winner-selection rule for an ABCP, and merchants need to agree on the rule before the ABCP starts.

When a merchant bears at least a partial cost of a particular ABCP, it is highly desirable that participating customers visit or interact with the merchant, after customers learn of the promotion. For example, the merchants may qualify a customer (i.e. an “entrant” into a contest or a sweepstake) only if the customer interacted with all of the participating merchants, which may maximize an advertising potential of the particular ABCP. Therefore, an entrant qualification and submission process for the particular ABCP may benefit from verifying that an interaction with a particular merchant took place.

Furthermore, forming alliances to cross-promote in a contest or a sweepstake format is an arduous task, as each participating sponsor entity must know that the other sponsor entities are interested in an ABCP and that they are comfortable with each other to promote together. In addition, they may need to reach a consensus on an optimal size of a prize for the ABCP and distribution of ABCP-related costs. Moreover, motivating potential customers to register with a particular ABCP, and keeping them interested during the course of the ABCP-based contest/sweepstakes is equally challenging. It is also difficult to keep track of the entrants who entered the ABCP-based contest/sweepstakes and their fulfillment of eligibility requirements according to specific award rules.

In addition, participating sponsor entities may want to monitor the current status and statistics related to a particular ABCP, so they can analyze the effectiveness of the particular ABCP efficiently and understand the impact of each participating sponsor entity on registration of participating customers, or entrants.

From the customers' perspective, it is important that they can access promotion and register to enter a particular ABCP. They may also want to access a current status related to the particular ABCP and maximize their efforts to win an award in the particular ABCP according to specific award rules.

Because organizing and managing an award-based cross promotion (ABCP) can be a daunting task, a system and methods which can facilitate and manage ABCP may be highly beneficial for business and group advertising activities.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a system and methods are provided to facilitate an initial organization (e.g. matching of sponsor entities), a creation of an award-based cross promotion (ABCP), and management activities related to participating businesses, entrants (e.g. customers entered into a contest or a sweepstake), and the ABCP. For the initial organization of interested sponsor entities in an ABCP, a system devised for the present invention allows a sponsor entity (e.g. a merchant) to search for other interested sponsor entities in joint promotions, with filtering capability to narrow down the potential partners. The present invention also allows sponsor entities to indicate their own interests in such promotions, so that the system can match sponsor entities of optimal mutual interests in ABCP-related activities.

Then, once a potential “pool” of sponsor entities or partners for ABCP-related activities are identified, the present invention facilitates an ABCP organizer to create an ABCP template, which allows selection of promotion period, desired award amount, winner-selection rules, etc. An ABCP management system can send invitations to the potential pool of sponsor entities for ABCP-related activities using emails or other electronic means after the ABCP template is created.

Furthermore, sponsor entities or partners interested in the potential pool for ABCP-related activities can provide feedback on the ABCP management system, and the ABCP organizer can adjust relevant parameters if necessary. A particular ABCP creation is completed after the ABCP award amount is fully funded, and the ABCP may be locked to disallow any additional sponsors or award-related rule changes. The present invention can then generate one or more unique codes (e.g. promotion codes and/or individual codes) for each participating sponsor entity in the ABCP. In a preferred embodiment of the invention, each merchant will have a unique and discrete set of codes, at least some of which can be provided to eligible customers (i.e. entrants) for participating in the ABCP event, which may be, but is not limited to, a contest or a sweepstake.

Furthermore, in the preferred embodiment of the invention, a participating sponsor entity may choose to provide a discrete code (a promotion code and/or an individual code) to an entrant only after an interaction with the sponsor entity (i.e. a merchant), thus ensuring that an interaction has taken place with the entrant. In one embodiment of the invention, the use of such codes can also help to prevent unwanted automated machine or accidental submission for an entrant. In another embodiment of the invention, the discrete code might also dictate the subsequent actions of the ABCP management system, such as directing the entrant to a different URL, or sending a different message to the entrant upon submission of the entry form.

In the preferred embodiment of the invention, when the ABCP creation is completed, the ABCP will become searchable by potential entrants and available for public view. Entry submission on the ABCP will be available when the promotion period starts, and becomes unavailable when the promotion period ends. An entrant who may have learned about an ABCP through a participating sponsor entity (e.g. a merchant), advertisements, or rumors can search to find the existing, ABCP's in the ABCP management system. The present invention also enables entrants to refine search of ABCP's by specifying parameters such as participating sponsors, geographical information of the ABCP, award amount, and etc.

Furthermore, an entrant can participate in an ABCP by filing a submission form electronically, or through paper mail. Depending on the selected qualification rules, the entrant might have to submit a code obtained from the sponsor entity along with the entry form. The submitted code might also dictate the subsequent actions of the ABCP management system, such as directing the entrant to a different URL or sending a different message to the entrant upon submission of the entry form. In one embodiment of the invention, the ABCP management system will keep track of all entry submission information, and provide the state of the ABCP to participating merchants through statistics generated from the submissions. Furthermore, the entrant can keep track of the state of the ABCP as well, so they can tune their efforts to increase their chances of winning the award.

Moreover, in one embodiment of the invention, the ABCP management system and/or its administrators can determine the winner of an award from the ABCP according to the specific award rules set by the participating sponsor entities. Once a winner is determined, the winner, who is one of the many eligible entrants participating in the ABCP activity such as a contest or a sweepstake, can be informed through the ABCP management system.

### BRIEF DESCRIPTION OF DRAWINGS

FIG. 1 shows a high-level conceptual system architecture for an award-based cross promotion (ABCP) management system, in accordance with an embodiment of the invention.

FIG. 2 shows an example of an organizer module associated with the ABCP management system, in accordance with an embodiment of the invention.

FIG. 3 shows an example of a merchant module associated with the ABCP management system, in accordance with an embodiment of the invention.

FIG. 4 shows an example of an entrant module associated with the ABCP management system, in accordance with an embodiment of the invention.

FIG. 5 shows an example of an ABCP management module associated with the ABCP management system, in accordance with an embodiment of the invention.

FIG. 6 shows an example of a communication module associated with the ABCP management system, in accordance with an embodiment of the invention.

FIG. 7 shows an example of a payment module associated with the ABCP management system, in accordance with an embodiment of the invention.

FIG. 8 shows a high-level flowchart of an ABCP lifecycle, in accordance with an embodiment of the invention.

FIG. 9 shows a merchant registration screenshot, in accordance with an embodiment of the invention.

FIG. 10 shows a screenshot for partnership interests among sponsor entities (e.g. merchants), in accordance with an embodiment of the invention.

FIG. 11a shows a conceptual diagram for matching of sponsor entities (e.g. merchants) from a mapping engine, in accordance with an embodiment of the invention.

FIG. 11b shows another conceptual diagram for matching of sponsor entities (e.g. merchant partners) from a mapping engine, in accordance with an embodiment of the invention.

FIG. 12 shows a conceptual diagram for category matching of profile attributes for sponsor entities (e.g. merchant partners) from a mapping engine, in accordance with an embodiment of the invention.

FIG. 13 shows a conceptual diagram for geometric proximity matching of profile attributes for sponsor entities (e.g. merchant partners) from a mapping engine, in accordance with an embodiment of the invention.

FIG. 14 shows a conceptual diagram for numeric matching of profile attributes for sponsor entities (e.g. merchant partners) from a mapping engine, in accordance with an embodiment of the invention.

FIG. 15 shows a conceptual diagram for tag matching of profile attributes for sponsor entities (e.g. merchant partners) from a mapping engine, in accordance with an embodiment of the invention.

FIG. 16 shows a conceptual diagram for a simple weighting system recommendation engine for potential partnership match of sponsor entities (e.g. merchant partners), in accordance with an embodiment of the invention.

FIG. 17 shows a conceptual diagram for notifying sponsor entities (e.g. merchants) for potential partnership, in accordance with an embodiment of the invention.

FIG. 18 shows an email message to a matched merchant for potential partnership with another merchant, in accordance with an embodiment of the invention.

FIG. 19 shows a web page interface for contacting matched potential sponsor partner entities, in accordance with an embodiment of the invention.

FIG. 20 shows an email received by a matched potential sponsor partner entity, in accordance with an embodiment of the invention.

FIG. 21 shows a conceptual diagram for creation of an ABCP campaign, in accordance with an embodiment of the invention.

FIG. 22 shows a flowchart for a sponsor entity (e.g. a merchant) ABCP participation process to an ABCP campaign, in accordance with an embodiment of the invention.

FIG. 23 shows a flowchart for a sponsor entity's (e.g. a merchant's) interaction with an ABCP management system, in accordance with an embodiment of the invention.

FIG. 24 shows a flowchart for an entrant's (e.g. a qualified customer's) interaction with an ABCP management system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and/or other symbolic representations that directly or indirectly resemble a method or a system for award-based cross promotions. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to systems and methods for award-based cross promotions (ABCP). In particular, embodiments of the invention relate to systems and methods which create, manage, implement, and/or support ABCP campaigns associated with an organizer of ABCP campaigns, sponsor entities (e.g. merchants), entrants (e.g. qualified customers related to sponsor entities), and specific award rules.

One objective of an embodiment of the present invention is to provide a portal system to create, manage, implement, and/or support ABCP campaigns for a campaign organizer, sponsor entities, entrants, and specific award rules, wherein the portal system promotes effective matching of partnerships among sponsor entities for a particular ABCP campaign and implementation of specific award rules for the particular campaign.

Furthermore, another objective of an embodiment of the present invention is to provide a coherent environment to create, manage, and conduct an ABCP campaign by linking relevant parties (e.g. sponsor entities, entrants, and an event organizer) of the ABCP campaign in a dedicated IT platform (i.e. an ABCP management system).

In addition, another objective of an embodiment of the present invention is to provide one or more systems and methods for ABCP campaigns as effective advertising tools for sponsor entities, potentially achieving higher sales and/or brand awareness for the participating sponsor entities by proactively involving entrants (e.g. qualified customers or potential customers of the participating sponsor-entities).

Yet another objective of an embodiment of the present invention is to provide a platform for joint funding of advertising opportunities in form of ABCP campaigns (e.g. joint sweepstakes campaigns by a pool of sponsor entities), which may reduce the financial burden of carrying an independent ABCP campaign per sponsor entity while increasing potential award amounts to entrants in at least some ABCP campaigns.

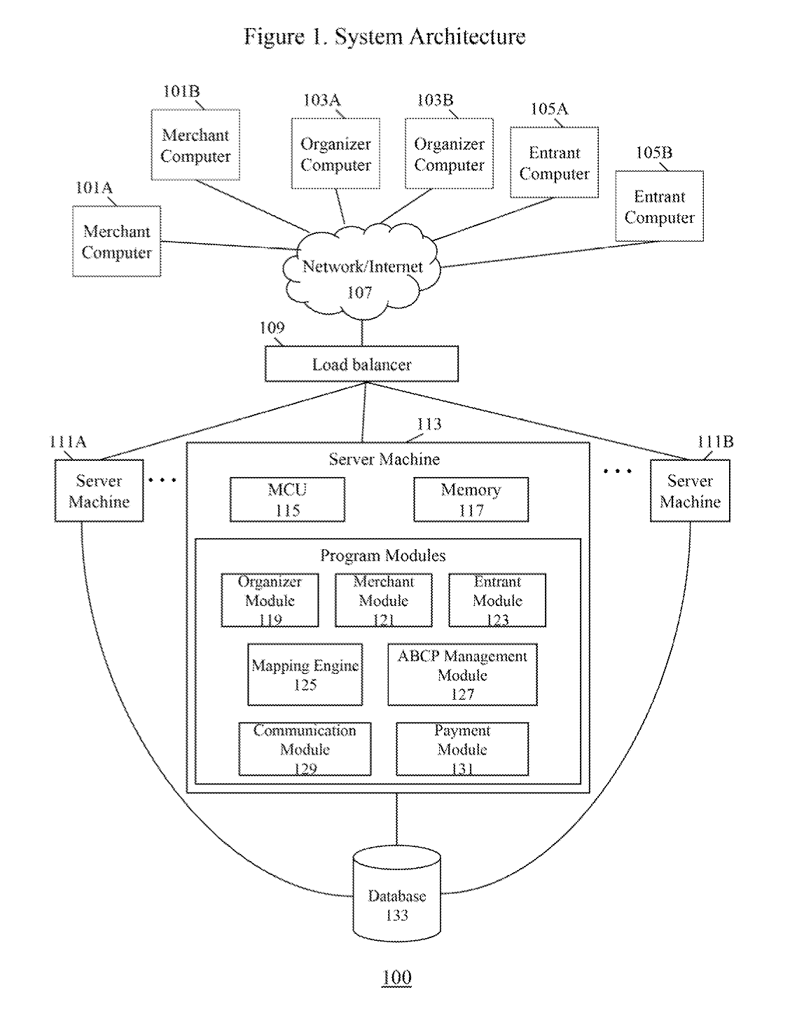

FIG. 1 shows a high-level conceptual system architecture (100) for an award-based cross promotion (ABCP) management system, in accordance with an embodiment of the invention. In a preferred embodiment of the invention, one or more sponsor entity's computers (e.g. merchant computers (101A, 101B)), one or more organizers' computers (103A, 103B), and one or more entrants' computers (105A, 105B) are operatively connected to a server machine (113) comprising a CPU/MCU (115), a memory unit (117), and one or more program modules. In one embodiment of the invention, sponsor entity's computers, organizers' computers, and entrants' computers may be desktop computers, notebook computers, mobile computing and communication devices (e.g. cellular phones, smart phones), another appropriate computing devices, or a combination thereof. In the preferred embodiment of the invention, the one or more program modules comprise an organizer module (119), a merchant module (121), an entrant module (123), a mapping engine (125), an ABCP management module (127), a communication module (129), and a payment module (131). The server machine (113) containing the one or more program modules may also be operatively connected to other server machines (111A, 111B), a database system (133), and/or a storage system. In the preferred embodiment of the invention, the database system (133) and/or the storage system may provide access to certain information related to sponsors, organizers, entrants, and other necessary data. In another embodiment of the invention, the mapping engine (125) may only be optional, or may not be part of the one or inure program modules.

In the preferred embodiment of the high-level conceptual system architecture (100) for the award-based cross promotion (ABCP) management system as shown in FIG. 1, the server machine (113), the merchant computers (101A, 101B), the organizers' computers (103A, 103B), and the entrants' computers (105A, 105B) may be operatively connected by a local area network (LAN), a wide-area network (WAN), and/or the Internet (107). A load balancer (109) which regulates the amount of connection or network traffic to the server machine (113) may also be utilized to prevent system latch-up caused by a surge in connection requests, network traffic, and/or a potential denial-of-service (DOS) attack to the server machine (113).

The present invention as shown by a high-level conceptual system architecture (100) in FIG. 1 allows sponsor entities (e.g. merchants) to formulate a joint funding pool to offer an award-based cross-promotion (ABCP) such as a sweepstake event or an award-based contest to eligible entrants, who are typically potential or current customers to the sponsor entities. In the preferred embodiment of the invention, each sponsor entity (e.g. each merchant) bears part of the overall cost of the award, which enables a larger award-based ABCP event. The larger award for a sweepstake event or a contest attracts more entrants to participate, which is a key advantage of an ABCP campaign vs. an individual sponsor-based campaign. In one embodiment of the invention, the funding for the joint funding pool may be a monetary funding pool in which sponsor entities contribute certain amount of money to the joint funding pool. In another embodiment of the invention, the funding for the joint funding pool may be based on vouchers, coupons, or another valuable asset which are contributed to the joint funding pool. Yet in another embodiment of the invention, the funding for the joint funding pool may be based on a combination of money, vouchers, coupons, or another valuable asset which are contributed to the joint funding pool.

The present invention also allows merchant machines (e.g. 101A, 101B) and entrant machines (e.g. 105A, 105B) to communicate with one or more server machines (e.g. 113) over a network (107). In the preferred embodiment of the invention, each server machine (113) comprises a microprocessor unit or a microcontroller unit (115) for computational processing, a memory module (117) for storing intermediate data, and a program module containing multiple modules, including the organizer module (119), the merchant module (121), the entrant module (123), the mapping engine (125), the ABCP management module (127), the communication module (129); and the payment module (131). En another embodiment of the invention, the mapping engine (125) may only be optional, or may not be part of the one or more program modules.

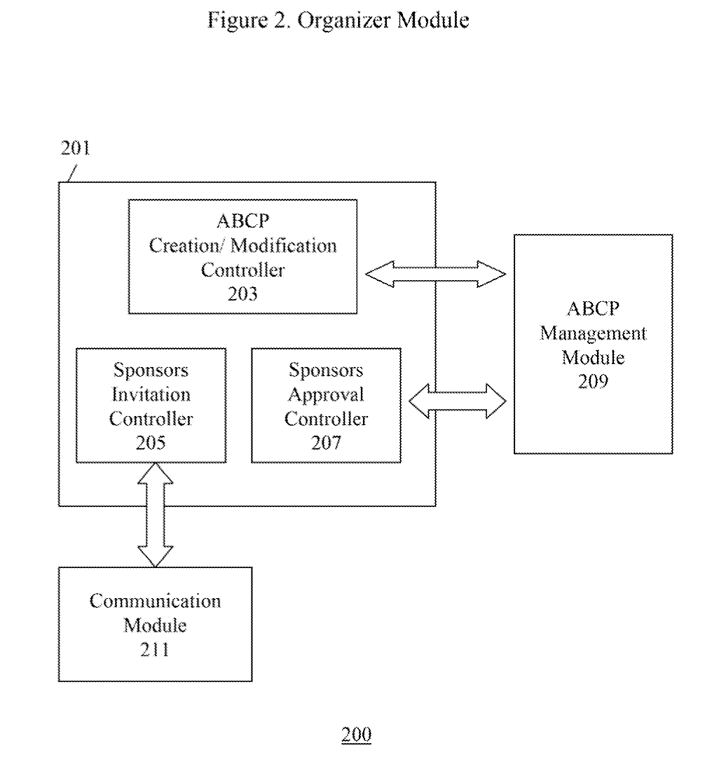

FIG. 2 shows an example (200) of an organizer module (201) associated with the ABCP management system, in accordance with an embodiment of the invention. In a preferred embodiment of the invention, the organizer module (201) comprises an ABCP creation/modification controller (203), a sponsor invitation controller (205), and a sponsor approval controller (207). The ABCP creation/modification controller (203) allows an organizer of an ABCP campaign (e.g. an organizer of joint sweepstakes campaign involving multiple sponsor entities for qualified entrants) to create and modify a particular ABCP campaign. In the preferred embodiment of the invention, the ABCP creation/modification controller (203) is operatively connected to the ABCP management module (209).

Furthermore, the sponsor invitation controller (205) in the organizer module (201) enables sponsor entities (e.g. merchants) to receive invitations from the organizer to participate in the particular ABCP campaign. In one embodiment of the invention, the invitations may be simply email invitations. In another embodiment of the invention, the invitations may be embedded in a web interface for access by relevant sponsor entities. In the preferred embodiment of the invention, the sponsor invitation controller is operatively connected to the communication module (211), which can further communicate with sponsor entities' (e.g. merchants') computers. In addition, the sponsor approval controller (207) in the organizer module (201) may be used to approve sponsor entities which desire to participate in the particular ABCP campaign created and/or managed by the organizer. The sponsor approval controller (207) may also be operatively connected to the ABCP management module (209).

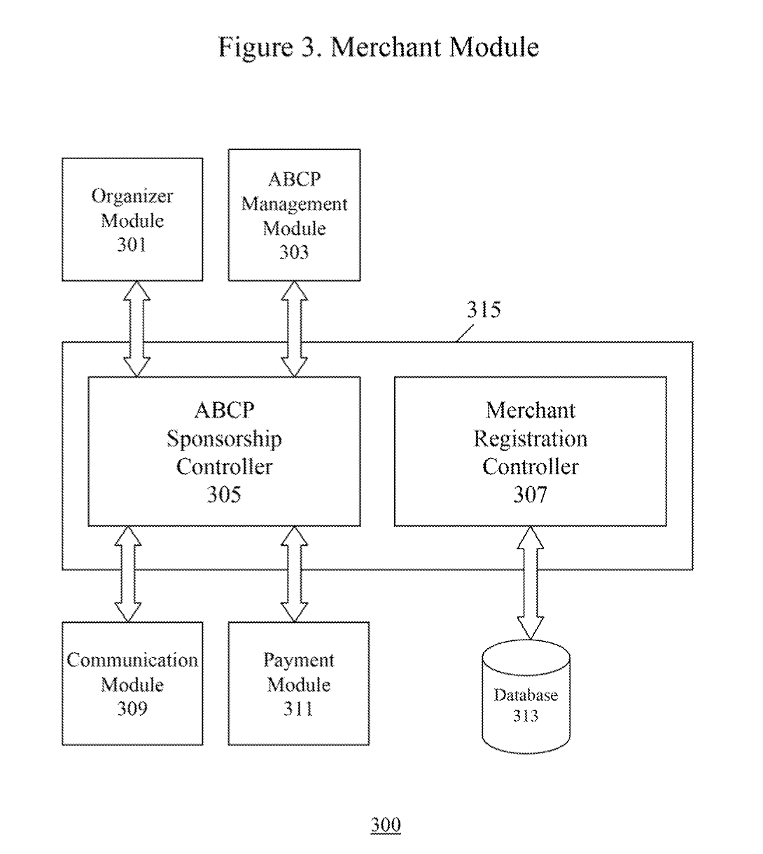

FIG. 3 shows an example (300) of a merchant module (315) associated with the ABCP management system, in accordance with an embodiment of the invention. In a preferred embodiment of the invention, the merchant module (315) comprises an ABCP sponsorship controller (305) and a merchant registration controller (307), which may be operatively connected to an organizer module (301), an ABCP management module (303), a communication module (309), a payment module (311). The merchant registration controller may also be operatively connected to a database system (313). In the preferred embodiment of the invention, the merchant module (315) allows an interested sponsor entity (e.g. an interested merchant) to participate in a particular ABCP campaign offered by an organizer and managed by the ABCP management module (303). The ABCP sponsorship controller (305) in the merchant module (315) may also receive sponsor-specific codes from a sponsor code generation module, which generates unique identifiers for a particular sponsor entity and/or an entrant to the particular ABCP campaign.

Furthermore, in the preferred embodiment of the invention, the ABCP sponsorship controller (305) also allows funding (e.g. money, vouchers, coupons, and etc.) or payments for the particular ABCP campaign for a particular sponsor entity using the payment module (311). Moreover, the communication module (309) operatively connected to the ABCP sponsorship controller (305) allows any desired communication between the merchant module to any desired node (e.g. an entrant's computer, an organizer's computer, a database system, and etc.) operatively connected to a network. In the preferred embodiment of the invention, the merchant registration controller (307) enables entry, modification, and/or deletion of a sponsor entity's registration information which may be stored in the database system (313).

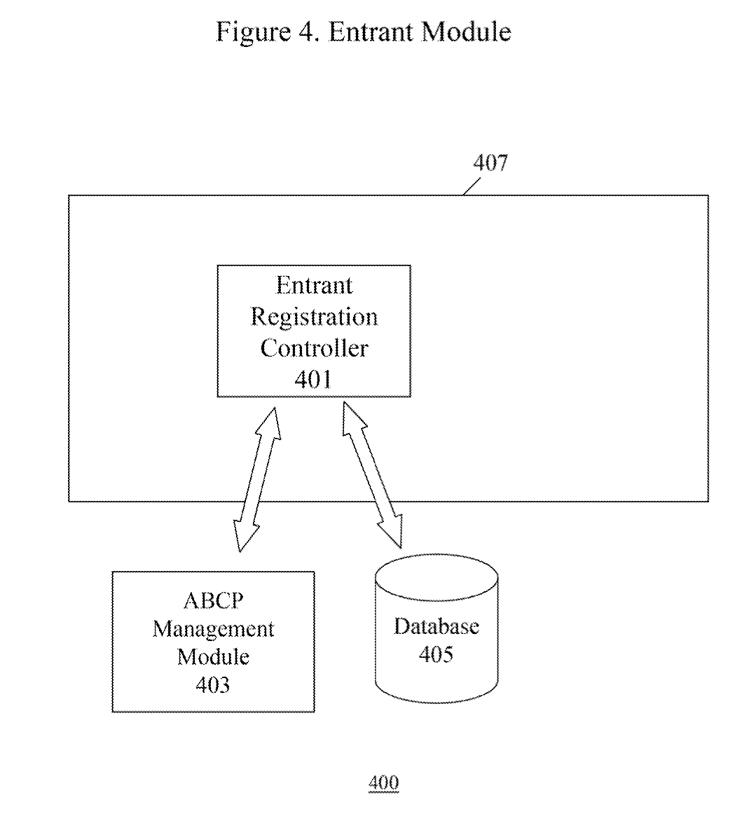

FIG. 4 shows an example (400) of an entrant module (407) associated with the ABCP management system, in accordance with an embodiment of the invention. In a preferred embodiment of the invention, the entrant module (407) comprises an entrant registration controller (401) which can be operatively connected to an ABCP management module (403) and a database system (405). The entrant module (407) can provide an interface to an entrant (e.g. a sweepstakes entrant who may be a qualified customer to a sponsor entity) to enter entrant-related information and sponsor code information to the ABCP management module (403) and/or the database system (405). Furthermore, the entrant module (407) may be configured to receive ABCP-related information or instruction from the ABCP management module (403) or the database system (405).

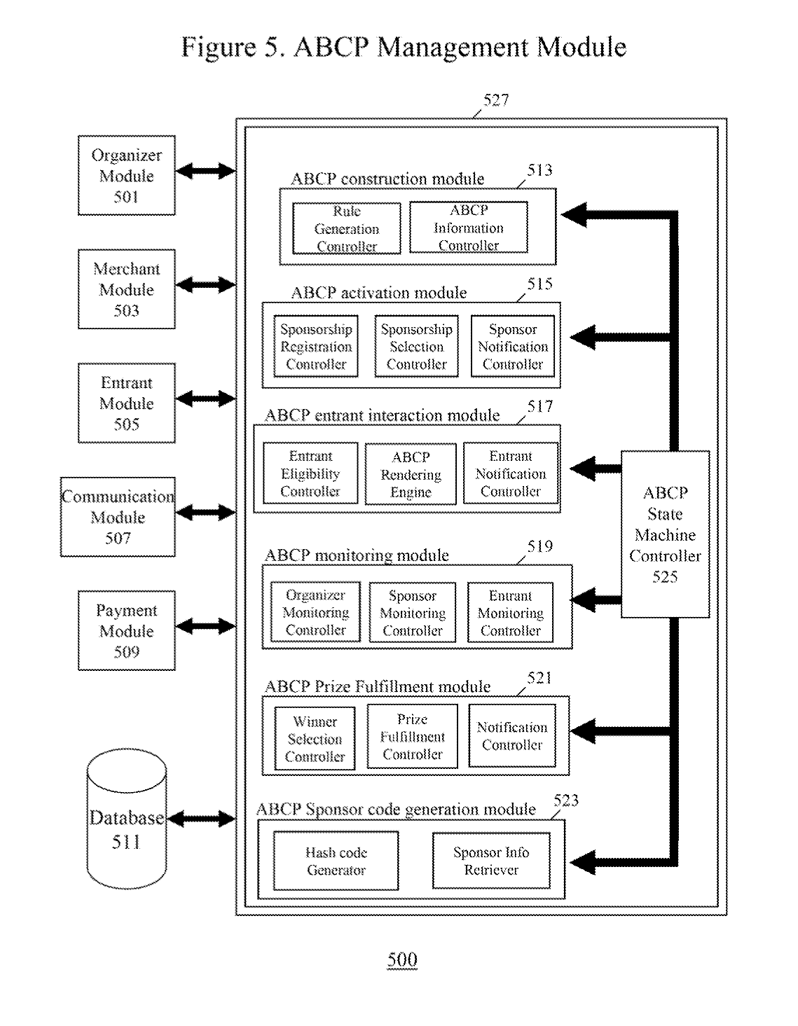

FIG. 5 shows an example (500) of an ABCP management module (527) associated with the ABCP management system, in accordance with an embodiment of the invention. In a preferred embodiment of the invention, the ABCP management module (527) comprises an ABCP construction module (513), an ABCP activation module (515), an ABCP entrant interaction module (517), an ABCP monitoring module (519), an ABCP sponsor code generation module (523), and an ABCP prize fulfillment module (521). An ABCP state machine controller (525) may also be operatively connected to any modules inside the ABCP management module (527), as shown in FIG. 5. In general, the ABCP management module (527) directs, determines, accommodates, and controls the behavior of an ABCP management system for interacting with an organizer, sponsor entities (e.g. merchants), and entrants (e.g. eligible customers).

In the preferred embodiment of the invention, the ABCP construction module (513) may further comprise a rule generation controller and an ABCP information controller. The ABCP construction module (513) may be generally responsible for creating an ABCP campaign with certain rules associated with the ABCP campaign (i.e. typically created by an organizer). Rules associated with the ABCP campaign may be generated at least in part by the rule generation controller, and at least some information or information access privileges associated with the ABCP campaign may be regulated by the ABCP information controller.

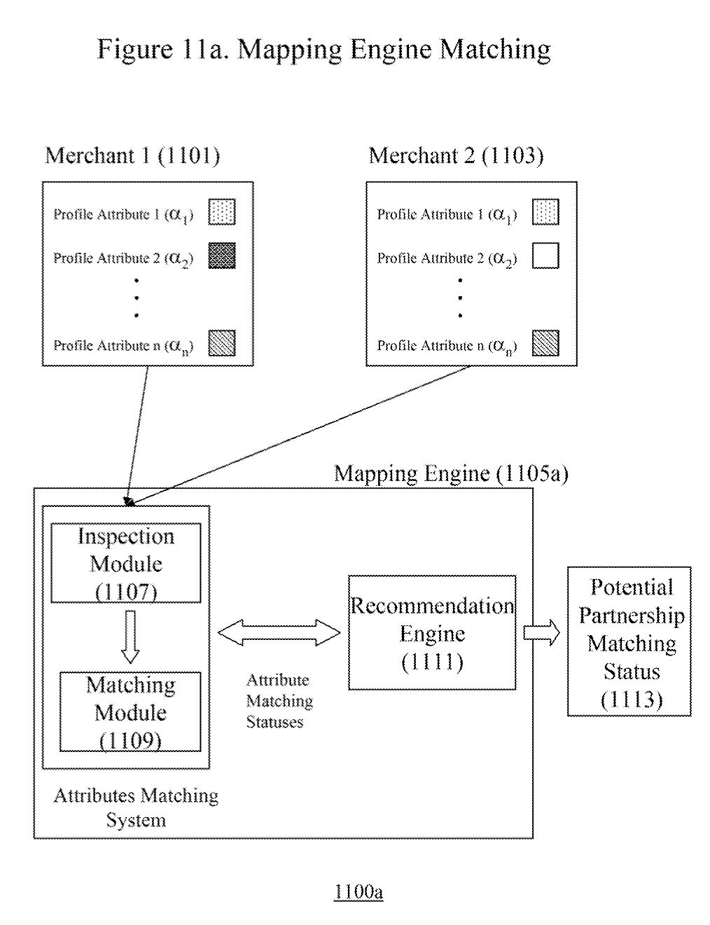

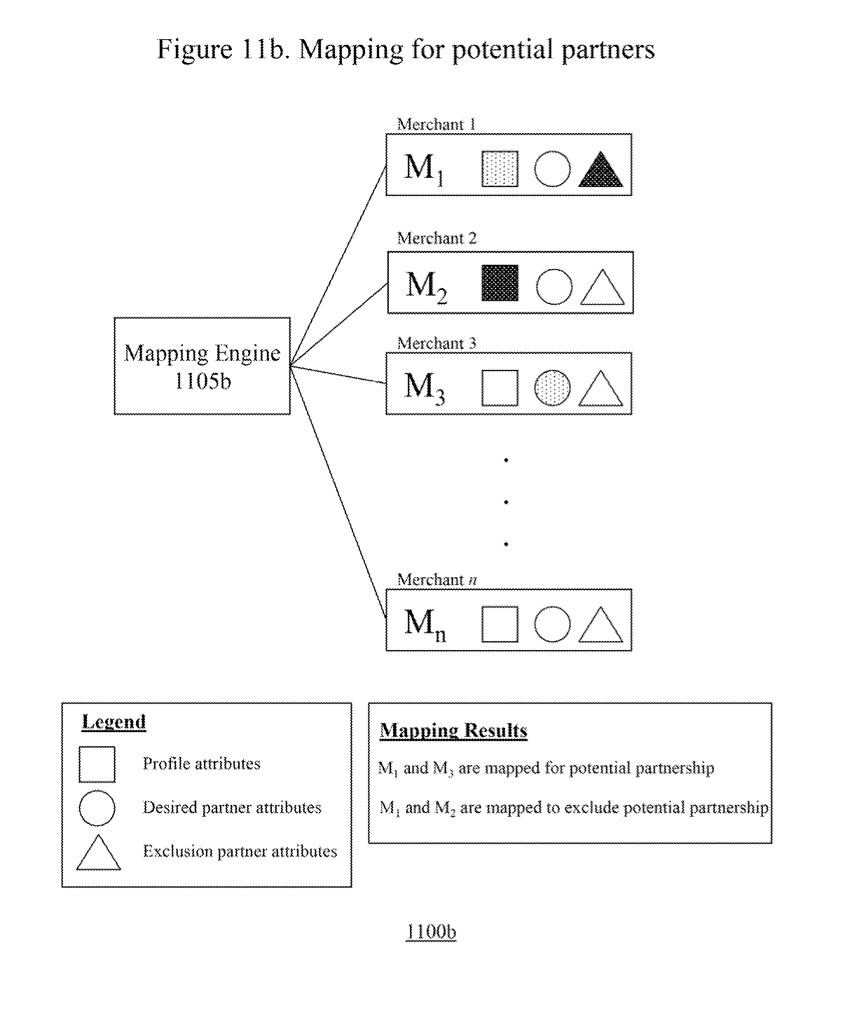

Furthermore, in the preferred embodiment of the invention, the ABCP activation module (515) may further comprise a sponsorship registration controller, a sponsorship selection controller, and a sponsor notification controller. The ABCP activation module (515) may be generally responsible for registering, selecting, and notifying sponsor entities for participation and joint funding (e.g. money, vouchers, coupons, and etc.) to a particular ABCP campaign which interests multiple sponsor entities. In one embodiment of the invention, the sponsorship registration controller can solicit, promote, and/or register information related to interested sponsor entities for the particular ABCP campaign. In another embodiment of the invention, the organizer can select one or more interested sponsor entities and invite those sponsors to fund the ABCP to become finalized sponsors. In another embodiment of the invention, initial sponsor entities which indicated interests to fund the ABCP before a specified sponsors limit is reached will become the final sponsors of the ABCP. In yet another embodiment of the invention, the sponsorship selection controller can determine which sponsor entities interested in the particular ABCP campaign are good matches for a joint participation and funding efforts. The matching of sponsor entities may be based on a variety of mapping algorithms described in the specification and FIG. 11˜16, or other methods known for one skilled in the art. Moreover, in one embodiment of the invention, the sponsor notification controller in the ABCP activation module (515) may be responsible for communicating with the sponsor entities for information related to ABCP activations, sponsor entity selections, and/or sponsor entity registrations.

Continuing with FIG. 5, in the preferred embodiment of the invention, the ABCP entrant interaction module (517) may be responsible for determining and notifying entrants for eligibility into a particular ABCP campaign and winner selection results. In one embodiment of the invention, the ABCP entrant interaction module (517) comprises an entrant eligibility controller, an ABCP rendering engine, and an entrant notification controller. Furthermore, in the preferred embodiment of the invention, the ABCP monitoring module (519) may be responsible for monitoring and regulating access privileges to organizers, sponsor entities, and entrants. In one embodiment of the invention, the ABCP monitoring module (519) may comprise an organizer monitoring controller, a sponsor monitoring controller, and an entrant monitoring controller.

In the preferred embodiment of the invention, the ABCP prize fulfillment module (521) within the ABCP management module (527) may be responsible for selecting a winner based on specific award rules using a winner selection controller, and executing the terms of a prize fulfillment using a prize fulfillment controller. The ABCP prize fulfillment module (521) may also contain a notification controller to notify relevant parties, which may involve a prize winner (from a group of entrants), one or more sponsor entities for a particular ABCP campaign, and an ABCP campaign organizer. The ABCP prize fulfillment module (521) may also interact with the payment module to distribute the ABCP award to the winners. The ABCP state machine controller (525) keeps track of the states of an ABCP, and interacts with the organizer module (501), the merchant module (503), the entrant module (505), the sponsor code generation module (523), the communication module (507), and the payment module (509) to determine the appropriate actions to be taken.

Continuing with FIG. 5, the ABCP sponsor code generation module (523) may be responsible for generating a sponsor-specific code which is a unique identifier for a particular sponsor entity in an ABCP campaign. A sponsor code can readily identify the particular sponsor entity for sweepstakes, contests, or other ABCP events, and the use of the sponsor code makes a sponsor-specific statistical analysis of entrants information easier. In one embodiment of the invention, the ABCP sponsor code generation module (523) may comprise a hash code generator and a sponsor info retriever, wherein the hash code generator produces one or more unique identifiers for a sponsor entity and the sponsor info retriever associates the unique identifiers from the hash code generator with a relevant sponsor entity. The ABCP management module (527) may be operatively connected to a database system (511) to access certain information related to sponsors, organizers, entrants, and other relevant data.

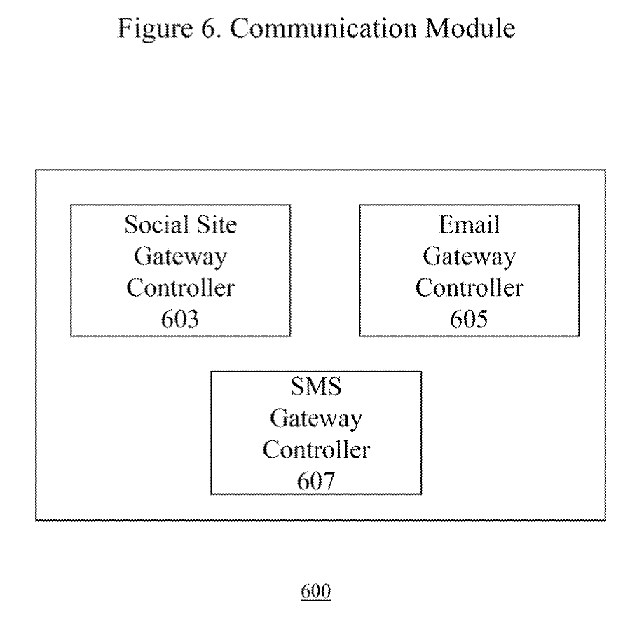

FIG. 6 shows an example of a communication module (600) associated with the ABCP management system, in accordance with an embodiment of the invention. In a preferred embodiment of the invention, the communication module (600) incorporates one or more methods to communicate with multiple entities, including, an organizer, sponsor entities, and entrants. As shown in FIG. 6, in the preferred embodiment of the invention, the methods of communication may include a social website using a social site gateway controller (603), an email communication using an email gateway controller (605), and a text message using an SMS gateway controller (607).

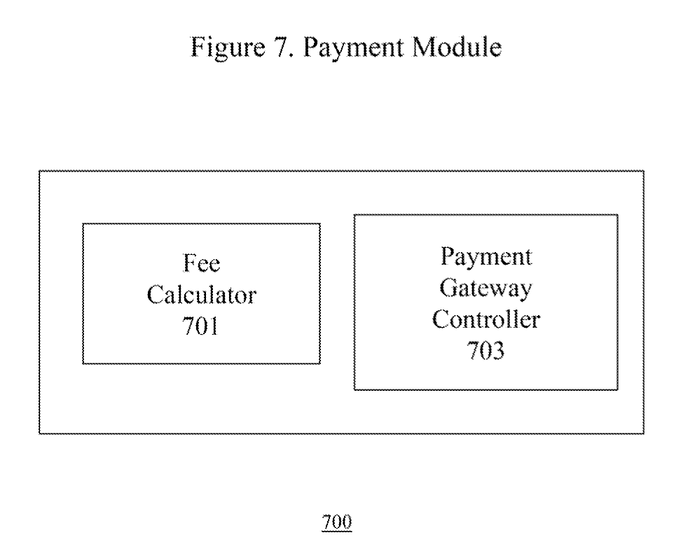

FIG. 7 shows an example of a payment module (700) associated with the ABCP management system, in accordance with an embodiment of the invention. In the preferred embodiment of the invention, the payment module (700) comprises a fee calculator (701), which can calculate the fees for using the ABCP system, and the cost for each sponsors relating to the award, and a payment gateway controller (703), which may be connected to an electronic payment system for credit card, e-check, and other methods of payment completion.

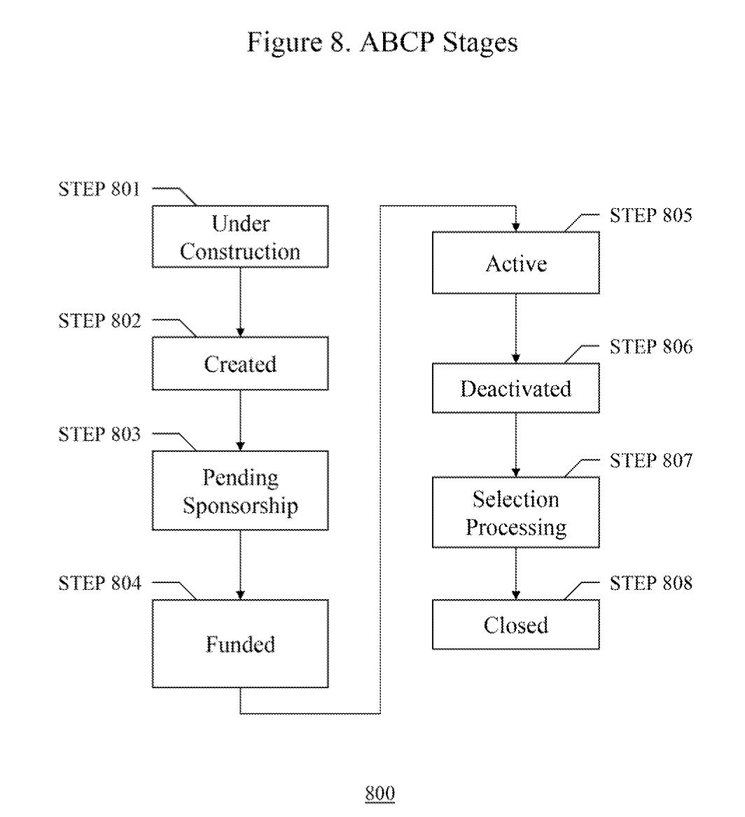

FIG. 8 shows a high-level flowchart (800) of an ABCP lifecycle, in accordance with an embodiment of the invention. Initially, an ABCP campaign may be created by a campaign organizer, which may also create award-specific rules and targeted sponsor entities (i.e. STEP 801). Then, once the ABCP campaign rules and sponsor entity criteria are defined (i.e. STEP 802), an ABCP management system can solicit, match, and/or advertise for sponsors' participation in the ABCP campaign (i.e. STEP 803). Once one or more sponsor entities commit to the ABCP campaign and are determined to be eligible to participate in the ABCP campaign, the ABCP management system can solicit and process joint funding payments (e.g. money, vouchers, coupons, and etc.) by sponsor entities committed to the ABCP campaign (i.e. STEP 804) using a payment module similar to an embodiment shown in FIG. 7.

Once all required joint funding payments are complete, the ABCP campaign can go into an “active” stage (i.e. STEP 805) in which qualified entrants (e.g. eligible customers to the participating sponsor entities) can enroll in an event (e.g. sweepstakes, award-based contest, and etc.) hosted through the ABCP campaign. Once the defined enrollment period of the entrants for the ABCP campaign is expired, or certain rules for expiring ABCP enrollment are met, the ABCP campaign is deactivated and closed for enrolling more entrants (i.e. STEP 806). Furthermore, one or more winners may be selected according to award-specific rules originally created and/or modified by the campaign organizer, and the winners can be notified of their selections via the ABCP management system (i.e. STEP 807). An ABCP campaign may be considered closed sometime after all the winners receive their awards (i.e. STEP 808).

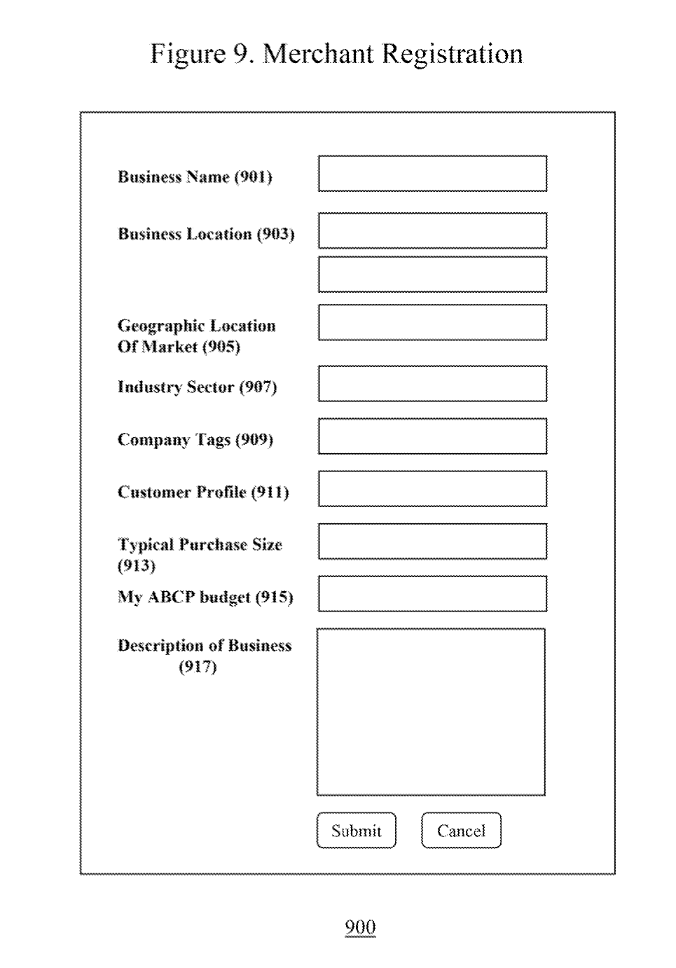

FIG. 9 shows a merchant registration screenshot (900), in accordance with an embodiment of the invention. Sponsor entities, such as online or offline merchants, can register their information in an ABCP management system. In one embodiment of the invention, the information at least contains a sponsor entity (e.g. a merchant) profile. In a preferred embodiment of the invention, each profile contains attributes describing the merchant. The attributes include but are not limited to:

Business name (901)

Contact information or business location (903)

Geographic locations of market (905)

Industry sector (907)

Company tags (909)

Customer profile (911)

Typical purchase size (913)

Business' ABCP budget (915)

Description of business (917)

As shown in FIG. 9, a merchant registration form can be filled out and submitted to the ABCP management system which may at least partially reside in a server machine operatively connected to a merchant computer through a network. Upon receipt of the sponsor entity-related (e.g. merchant-related) information, the ABCP management system can capture desirable attributes and store them in a database system.

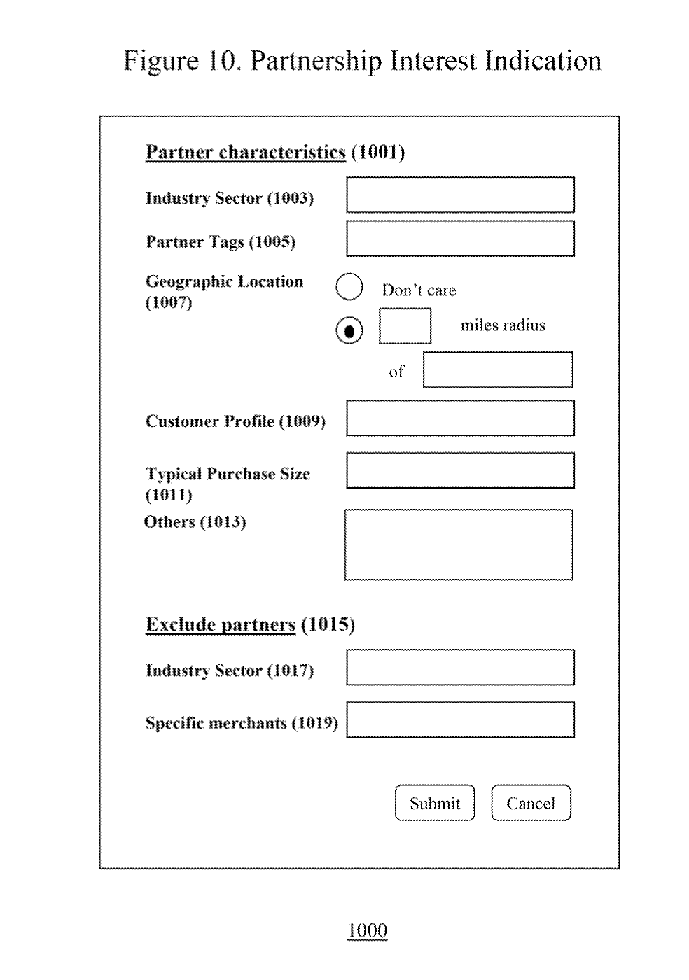

FIG. 10 shows a screenshot (1000) for partnership interests among sponsor entities (e.g. merchants), in accordance with an embodiment of the invention. In one embodiment of the invention, a merchant can use a merchant computer to communicate with the ABCP management system which incorporates a merchant module, wherein the merchant module enables data entry and access to potential sponsor entity partnership search for ABCP-related activities or campaigns. In the preferred embodiment of the invention, the merchant module may prompt the merchant to state the attributes of desired partners (e.g. other sponsor entities for partnership). The merchant seeking partners can also specify characteristics of partners which should be excluded from the partnership search efforts (e.g. “exclude partners” section in the screenshot of FIG. 10). Exclusion criteria for partnership search enables a sponsor entity to exclude its direct competitors or undesirable entities from partnership considerations. For partnership search efforts, attributes of a desired partner may be called “partner characteristics” (1001), which includes the following fields:

Industry sector (1003)

Partner tags (1005)

Geographic location (1007)

Customer profile for the desired partner (1009)

Typical purchase size of the desired partner (1011)

Other characteristics (1013)

Furthermore, the merchant module can also capture the merchant's desired

ABCP budget for each ABCP campaign to minimize any mismatched expectations for potential partners. In addition, it may be desirable to exclude certain partners from the partnership interest indication interface by including an interface to exclude partners (1015). In a preferred embodiment of the invention, a certain industry sector (1017) and/or a specific merchant (1019) can be excluded from the partnership interest indication interface, as shown in FIG. 10. Once the desired partners' attributes are captured from the partnership interest indication interface, they can be stored in a database system associated with the ABCP management system.

FIG. 11a shows a conceptual diagram (1100a) for matching of sponsor entities (i.e. merchant 1 (1101), merchant 2 (1103)) from a mapping engine (1105a), in accordance with an embodiment of the invention. In a preferred embodiment of the invention, the mapping engine (1105a) is used to match potential partners to form an ABCP partnership. In one embodiment of the invention, an inspection module (1107) can be used to inspect attributes of a merchant's profile data and attributes of other merchants' declaration for desirable partners. The inspection module (1107) also interfaces with an attributes matching module (1109) to determine if the attributes are matched. A recommendation engine (1111) then takes the potential partnership matching statuses (1113) to determine an appropriate match for a potential partnership.

FIG. 11b illustrates the mapping engine (1105b) inspecting over all existing merchant data to find matches for potential partnerships (1100b). In this example, merchant 1 (M1) and merchant 3 (M3) are mapped for potential partnership because attributes in merchant 1's (M1's) profile data match the attributes for desired partner for merchant 3 (M3). Also, merchant 1 (M1) and merchant 2 (M2) are excluded from forming a partnership because attributes in merchant 1's (M1's) profile data match the attributes of an excluded partner (e.g. 1015 of FIG. 10) for merchant 2 (M2).

In another embodiment of the invention, in order to map potential partners, profile attributes of a merchant may be matched against the corresponding desired partnership attributes of another merchant utilizing various matching algorithms.

The matching may utilize one or more of the following methods, which may be used singularly or in combination:

Category matching

Geographic proximity matching

Numeric matching

Keyword/Tag matching

K-nearest neighbor algorithm (k-NN)

Collaborative filtering

Singular value decomposition

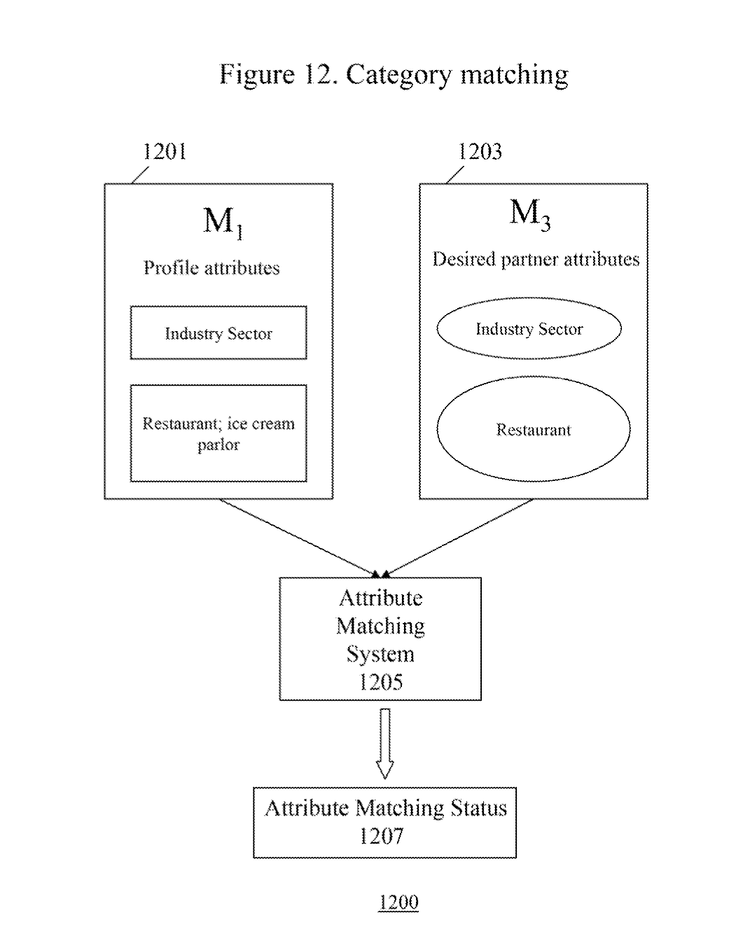

FIG. 12 shows a conceptual diagram (1200) for category matching of profile attributes (i.e. 1201, 1203) for sponsor entities (e.g. merchant partners M1 and M3) from a mapping engine, in accordance with an embodiment of the invention. This figure illustrates category matching for attributes in profile data and attributes in desired partner declaration. In a preferred embodiment of the invention, a merchant module defines a pre-defined set of industry sectors for merchants, similar to how yellow pages define categories for business listing. By analyzing and inspecting the relevance or closeness of the industry sectors of a merchant and the desired partner declaration of another merchant, the attributes matching system module (1205) can determine if their categories match each other, and subsequently confirm a successful matching by generating an attribute matching status (1207).

In a preferred embodiment of the invention, the category matching of profile attributes may derive relevance or closeness of matched categories by using computational and analytical methods such as K-nearest neighbor algorithm (k-NN), collaborative filtering, and/or singular value decomposition. For example, an embodiment of a k-NN algorithm may associate profile attributes to be matched (i.e. 1201) with one or more desired partner attributes (i.e. 1203 and etc.) whose categories are closely associated with those of the profile attributes to be matched. In one embodiment of the invention, the close association may be defined by similarities or matching of a numerical coordinate or a number assigned to a category in a profile attribute.

Furthermore, in one embodiment of the invention, a more generalized case of K-nearest neighbor algorithm called “collaborative filtering” (CF) algorithm may also be used to look for desired partner attributes (i.e. 1203) whose categories share highly-relevant patterns to those of the profiles attributes to be matched (i.e. 1201). It should be noted that the K-nearest neighbor algorithm is a particular case of the collaborative filtering (CF), wherein the highly-relevant patterns are categorized by nearest Euclidian distance or closely-resembling data sets in the K-nearest neighbor algorithm. In one embodiment of the invention, more generalized collaborative filtering (CF) algorithms may also be utilized to improve matching relevance among sponsor entities (e.g. M1, M3, and etc.) beyond geometrical proximity or data set resemblance often utilized in a K-nearest neighbor algorithm.

Furthermore, another statistical analysis algorithm called “singular value decomposition” may be utilized to provide an improved matching relevance among sponsor entities (e.g. M1, M3, and etc.). In one embodiment of the invention, the singular value decomposition factorizes a real-number or complex-number matrix to derive a predictive result in “least square fitting” of data and matrix approximation. For example, a plurality of desired partner attributes (e.g. 1203 and etc.), which are represented as scattered data points along a curvature representing the profile attributes to be matched (i.e. 1201), may be analyzed using the singular value decomposition to determine which particular desired partner attributes are most relevant to the profile attributes to be matched. (i.e. 1201).

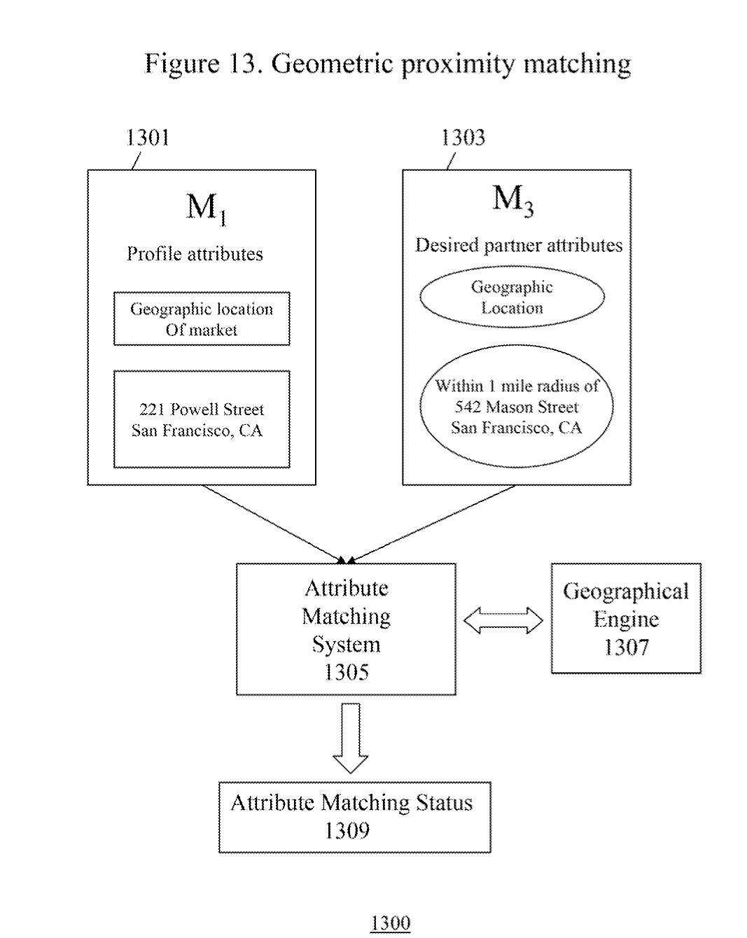

FIG. 13 shows a conceptual diagram (1300) for geometric proximity matching of profile attributes (1301, 1303) for sponsor entities (e.g. merchant partners M1 and M3) from a mapping engine, in accordance with an embodiment of the invention. This figure illustrates geographic proximity matching for profile attributes (1301) of a sponsor entity to be matched (M1) and desired partner attributes (1303) for a potential partner (M3). In a preferred embodiment of the invention, the attributes matching system module (1305) inspects the geographical location attribute specified in a merchant's profile against the geographic location preference attribute of a desired partner declaration of another merchant, and query a geographical engine (1307) such as those provided by Google Maps or MapQuest, to determine whether there is a desirable match, as indicated by an attribute matching status (1309). In the example shown in FIG. 13, a successful matching is warranted because merchant M1's market is within 1 mile radius of the specified location in the desired partner declaration of M3.

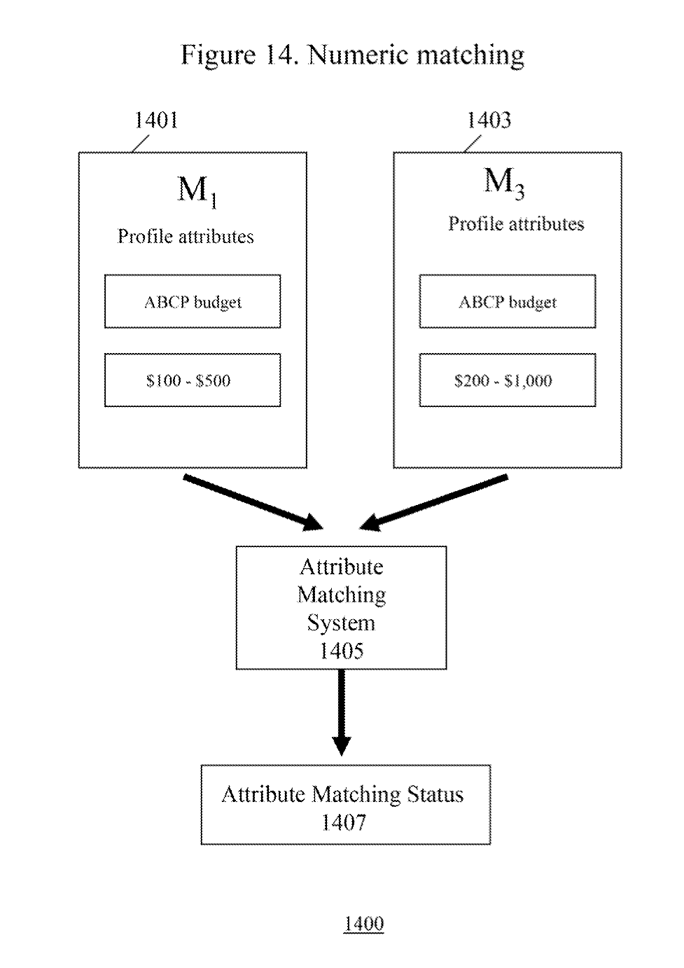

FIG. 14 shows a conceptual diagram (1400) for numeric matching of profile attributes (1401, 1403) for sponsor entities (e.g. merchant partners M1 and M3) from a mapping engine, in accordance with an embodiment of the invention. This figure illustrates numeric matching for profile attributes (1401) of a sponsor entity to be matched (M1) and desired partner attributes (1403) for a potential partner (M3). In this particular example, the attributes matching system module (1405) inspects and compares the ABCP budgets of M1 and M3, and determines that the numeric ranges overlap. An attribute matching status (1407) may be generated to indicate that there is at least some numerical matching between the profile attributes (1401) of the sponsor entity to be matched (M1) and the desired partner attributes (1403) for the potential partner (M3).

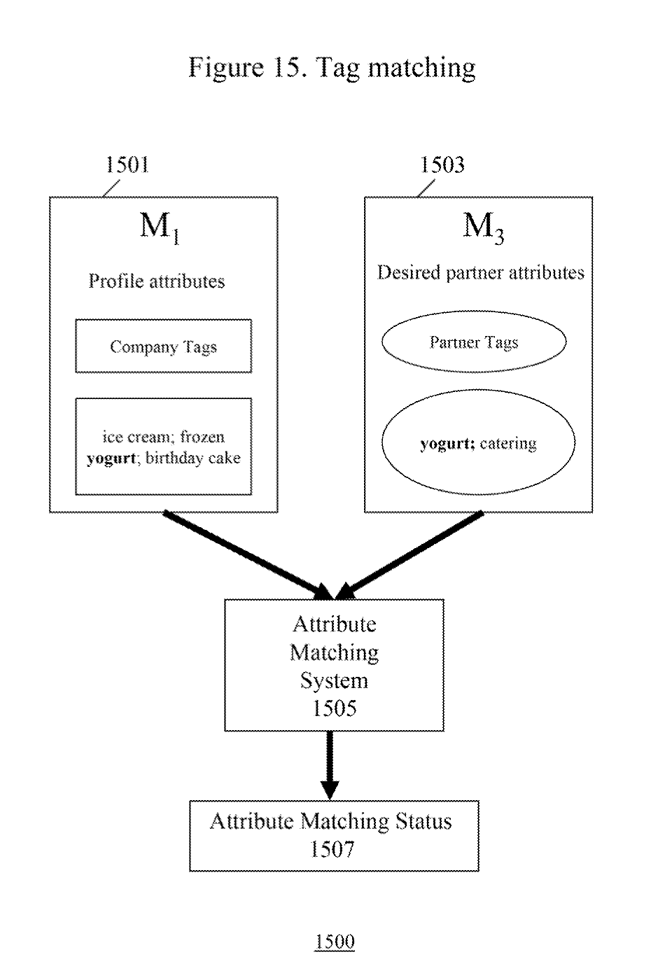

FIG. 15 shows a conceptual diagram (1500) for tag matching of profile attributes (1501, 1503) for sponsor entities (e.g. merchant partners M1 and M3) from a mapping engine, in accordance with an embodiment of the invention. This figure illustrates tag matching for profile attributes (1501) of a sponsor entity to be matched (M1) and desired partner attributes (1503) for a potential partner (M3). In one embodiment of the invention, tags are keyword attributes that a merchant can use to enhance its profile. For example, an ice cream store simply categorized under the “Restaurant” category may not have a sufficiently fine grain of detail to describe its business effectively. The merchant may want to add ‘ice cream’, ‘frozen yogurt’, ‘birthday cake’, etc. to further describe its business so other merchants looking for partnership can easily find them. These keywords are stored as tags in the corresponding attributes, and the attributes matching system module (1505) can perform keyword matching to determine a desirable match, which may be indicated in an attribute matching status (1507).

In a preferred embodiment of the invention, the recommendation engine may take attribute matching results between the attributes in a merchant's profile data and the attributes in a potentially desired partner (e.g. another merchant) in order to determine whether a merchant is a potentially good partner of another merchant. The recommendation engine may be a plug-in module to the mapping engine, and different recommendation engines could be used for matching potential partnerships for different types of cross-promotions (e.g. a recommendation engine for merchants joining together to issue joint coupons could be different from another recommendation engine which assists multiple merchants seeking ideal partners to conduct ABCP campaigns jointly).

Furthermore, as explained previously in conjunction with FIG. 12, the relevance or closeness as a successful match between a sponsor entity (e.g. M1) and another sponsor entity (e.g. M3) may be derived from computational and analytical methods such as K-nearest neighbor algorithm (k-NN), collaborative filtering, and/or singular value decomposition. The k-NN algorithm can be used to associate profile attributes to be matched (e.g. 1201, 1301, 1401, 1501) with one or more desired partner attributes (e.g. 1203, 1303, 1403, 1503) whose categories (i.e. FIG. 12), geographic proximities (i.e. FIG. 13), numerical factors (i.e. FIG. 14), and/or tags (i.e. FIG. 15) are closely associated with those of the profile attributes to be matched. In some embodiments of the invention, the close association may be defined by similarities or matching of a numerical coordinate or a number assigned to a category, a geographic location, a quantitative range, and/or a tag in a profile attribute. Therefore, in some embodiments of the invention, examples of matching techniques illustrated and described for FIGS. 12-15 may utilize the K-nearest neighbor algorithm (k-NN) if it is desirable for those particular embodiments of the invention.

Similarly, a more generalized case of K-nearest neighbor algorithm called “collaborative filtering” (CF) algorithm may also be used in one or more matching techniques illustrated and described for FIGS. 12-15 to identify highly-relevant patterns in desired partner attributes (e.g. 1203, 1303, 1403, 1503) to those of the profiles attributes to be matched (e.g. 1201, 1301, 1401, 1501). It should be noted that the K-nearest neighbor algorithm is a particular case of the collaborative filtering (CF), wherein the highly-relevant patterns are categorized by nearest Euclidian distance or closely-resembling data sets in the K-nearest neighbor algorithm. In one embodiment of the invention, more generalized collaborative filtering (CF) algorithms may also be utilized to improve matching relevance among sponsor entities (e.g. M1, M3, and etc.) beyond geometrical proximity or data set resemblance often utilized in a K-nearest neighbor algorithm.

Furthermore, another statistical analysis algorithm called “singular value decomposition” may be utilized to provide an improved matching relevance among sponsor entities (e.g. M1, M3, and etc.) for one or more matching techniques illustrated and described for FIGS. 12-15. In one embodiment of the invention, the singular value decomposition factorizes a real-number or complex-number matrix to derive a predictive result in “least square fitting” of data and matrix approximation. For example, a plurality of desired partner attributes (e.g. 1203, 1303, 1403, 1503), which are represented as scattered data points along a curvature representing the profile attributes to be matched (e.g. 1201, 1301, 1401, 1501), may be analyzed using the singular value decomposition to determine which particular desired partner attributes are most relevant to the profile attributes to be matched.

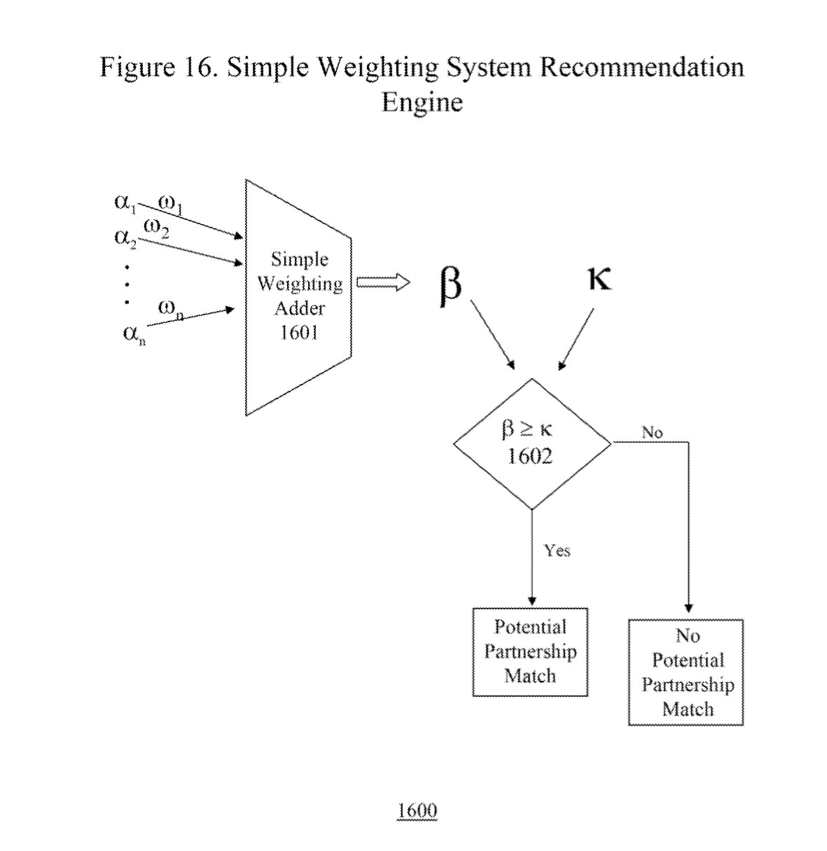

FIG. 16 shows a conceptual diagram (1600) for a simple weighting system recommendation engine for potential partnership match of sponsor entities (e.g. merchant partners), in accordance with an embodiment of the invention. This is an example of a recommendation engine which could be used in an ABCP management system. The recommendation engine as shown in FIG. 16 uses a weighting system on the attribute matching results to determine the potential partnership between two merchants, in order to account for the relative importance of different attributes (e.g. geographical location matching could be more important than matching of ABCP budget, and ABCP budget could be more important than industry sector, etc.).

A Simple Weighted System Recommendation Engine (SWSRE) is detailed below to illustrate how one can match potential partnership between two merchants. In the SWSRE, the matching results of attributes are assigned a value a, and is then weighted and summed together in a simple weighting adder (1601) to yield a value β. The resulting value β is compared to an arbitrary value κ, and potential partnership matching is confirmed if β≧κ (1602). A formula is shown below to illustrate this relationship.

$$β = {\sum }_{i = 0}^{n} {ω}_{i} {α}_{i}$$

if β≧κ then there is a match potential partnership

wherein αᵢ is a value assigned to the matching result between an attribute of a merchant's profile data and an attribute of another merchant's desirable partner declaration, ωᵢ is the weight assigned to the attribute matching, and β is the final value used to determine whether the two merchants are matched for potential partnership. An example for determining the potential partnership is shown with values of ω and α for different attribute matching using the following table. In the example, a value of 50 is chosen for κ to determine the final match for potential partnership.

| | |
|---|---|
| Match | No Match |

| | ω | α | ω | α |
|---|---|---|---|---|
| Industry Sector | 50 | 1 | 50 | 0 |
| ABCP Budget | 10,000 | 0 | 10,000 | −1 |
| Geographical Location | 10,000 | 0 | 10,000 | −1 |
| Tags | 1 | 10-50 | 1 | 0 |

In the table, the value of ω and α are shown for the matching of each corresponding attribute between two merchants. For matching of Tags, a value is returned between 10 and 50 depending on the degree of matching.

| | Case 1 | Case 2 |
|---|---|---|
| Industry Sector | ✓ [symbol] 50 | ✓ [symbol] 50 |
| ABCP Budget | ✓ [symbol] 0 | ✓ [symbol] 0 |
| Geographical Location | ✓ [symbol] 0 | [symbol] [symbol] −10,000 |
| Tags | [symbol] [symbol] 0 | [symbol] [symbol] 0 |
| β | 50 | −9,950 |
| β ≧ κ (50) | True | False |

In case 1, Matches are confirmed for Industry Sector, ABCP budget, and geographical location, and β is evaluated to 50, and thus a matching for potential partnership is confirmed. In case 2, matches are only confirmed for Industry Sector and ABCP budget, and β is evaluated to −9,950, and thus a matching for potential partnership is not confirmed

Besides putting up characteristics of desirable partners, merchants can also specify characteristics of undesirable partners. For example, an ice cream store merchant might want to partner with deli owners within a one-mile radius of its store, while excluding all other ice cream stores in the area as they compete directly. In such instances, the Mapping Engine can be used for matching attributes of a merchant's profile data and attributes of the undesirable partner declaration, except that when a match is found, the two merchants may be excluded for potential partnership. If two merchants are excluded for potential partnership in the exclusion matching, it may overrides any other matching characteristics for potential partnership.

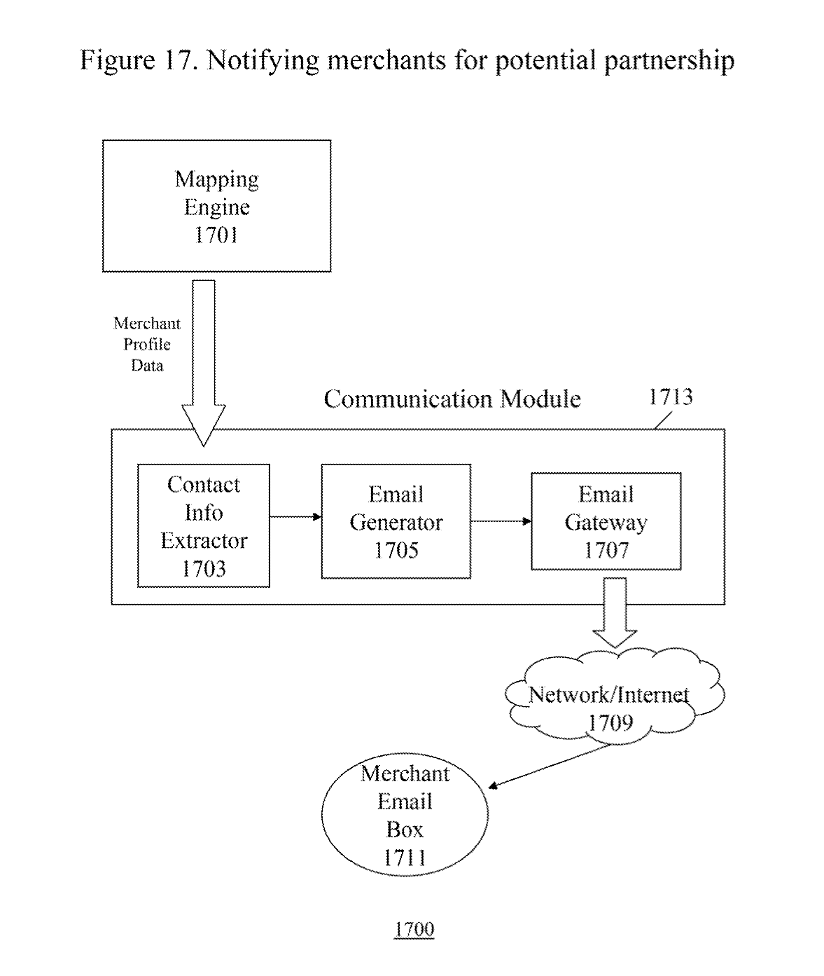

FIG. 17 shows a conceptual diagram (1700) of a communication module system architecture for notifying sponsor entities (e.g. merchants) for potential partnership, in accordance with an embodiment of the invention. In a preferred embodiment of the invention, if the mapping engine (1701) produces any potential partnership match for a merchant, it passes the profile data of the matched merchant to the communication module (1713). Within the communication module (1713), a contact info extractor (1703) extracts the merchant contact information from the merchant's profile data, and constructs an email message with an email generator (1705), which generates an email message to be sent to an email gateway (1707). The email gateway (1707) interacts with the internee (1709) and delivers it to the email box (1711) of the merchant.

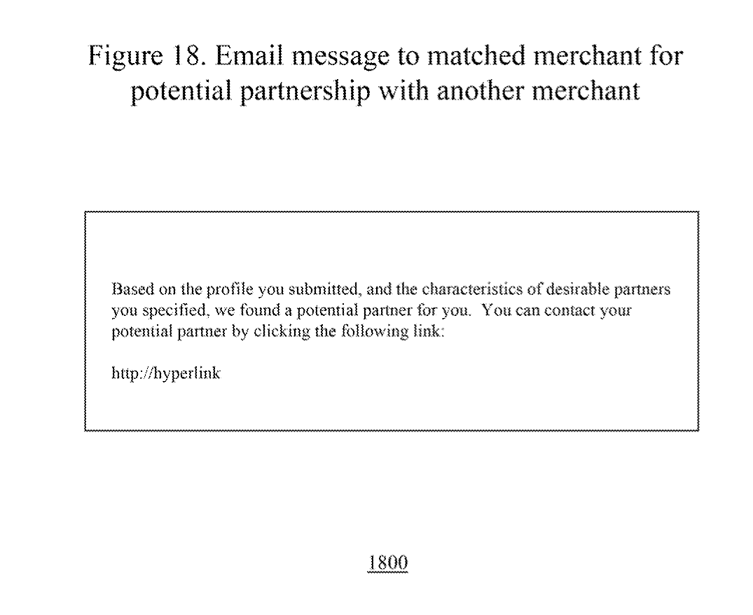

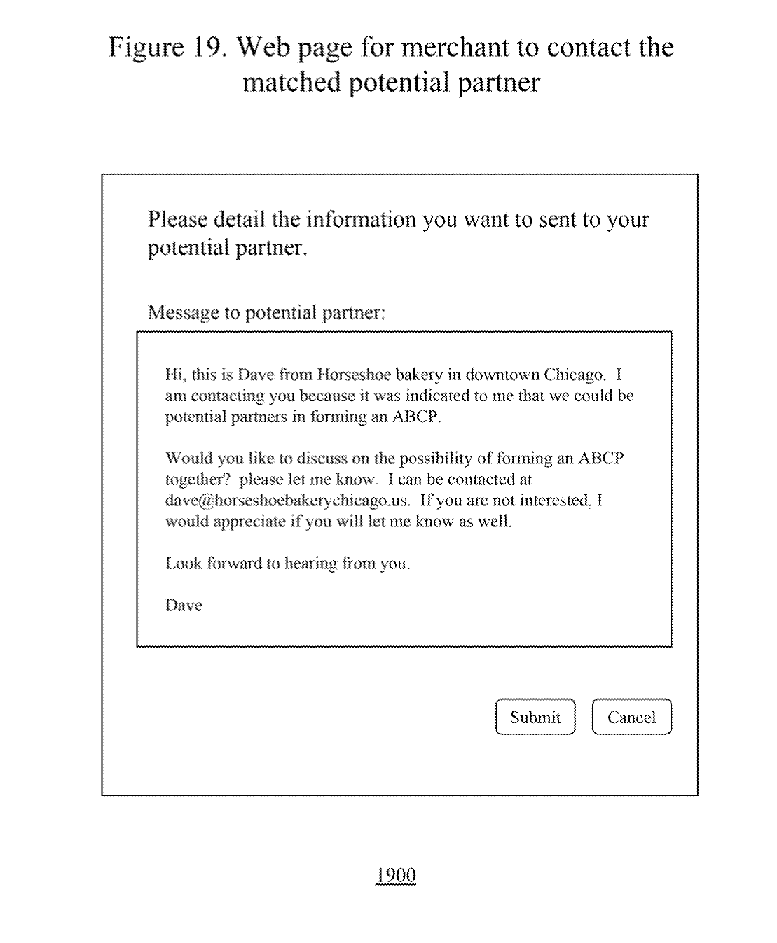

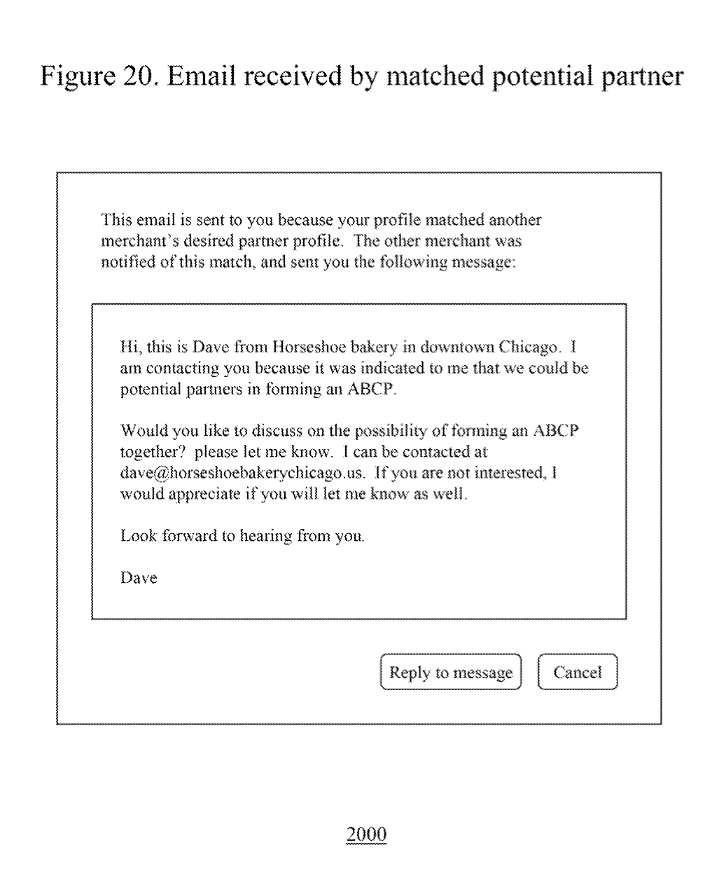

FIG. 18 shows an email message (1800) to a matched merchant for potential partnership with another merchant, in accordance with an embodiment of the invention. This figure illustrates the body of an email being sent to a merchant that is matched for potential partnership. The email message contains a link to a web page (1900), as shown in FIG. 19, for the merchant to contact the potential partner. Upon submitting the message, the communication module can transmit an email to the matched potential partner. Furthermore, FIG. 20 shows an email (2000) received by a matched potential sponsor partner entity, in accordance with an embodiment of the invention.

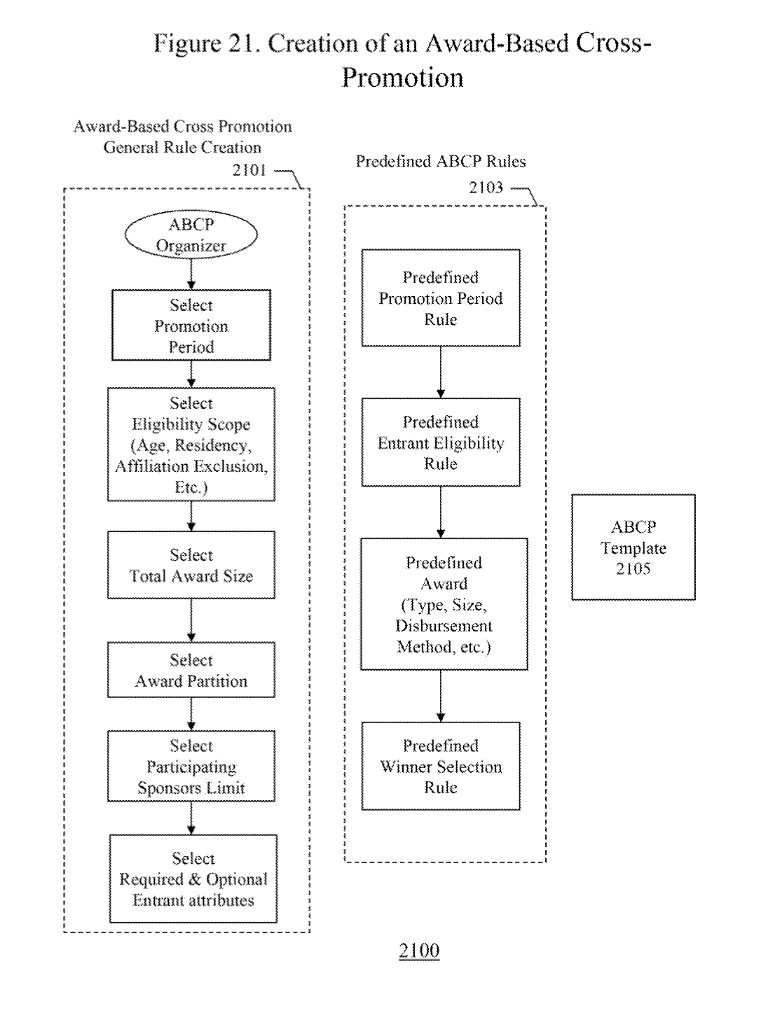

FIG. 21 shows a conceptual diagram (2100) for creation of an ABCP campaign, in accordance with an embodiment of the invention. To create an ABCP for merchants, an ABCP organizer, who may be a third party promoter or a sponsor entity (e.g. a merchant) which desires to engage in an ABCP with others, needs to register on the ABCP management system and provide its profile data for registration process. In one embodiment of the invention, the ABCP organizer starts the ABCP creation process by interfacing with the server to create an ABCP template (2105) on the server. The ABCP template (2105) may comprise a set of attributes that are used to specify the time period of the promotion, details of the award, participation details for merchants, qualifications of the entrants, details of entries submission, and schemes for winner selection.

The ABCP template (2105) captures the scope of the ABCP, which may include but are not limited to the following:

Promotion period
Start date of promotion
End date of promotion

Details of Award
Award type and value of award (e.g. Cash, Gift Card, etc.)
Number of winners for awards
Award distribution for winners

Merchant participation details
Limitation on number of participating merchants
Merchant award contribution distribution

Entrant qualification
Age limit
Residency limitation
Affiliate exclusion

Entry submission details
Entrant contact information
Required attached material (e.g.'essay in an essay contest)
Allowable number of entries per entrant
Allowable number of entries per defined period
Purchase requirement
Merchant code usage
   Merchant code requirement per entry
      Merchant code collection method
      Allowable merchant codc usage frequency

Winner-Selection scheme
Arbitrary winner selection (random drawing) from sweepstakes
Contest-based winner selection based on entrants' specific award rule-related performances

In one embodiment of the invention, the ABCP management system will present an interface to guide the creation process to capture the needed parameters for an ABCP. An interface may also be presented which has ABCP rules such as age limitation, geographic region, and etc. to help an organizer to choose the parameters more easily.

In a preferred embodiment of the invention, rule creation may be categorized into an ABCP general rule creation (2101) and a predefined set of ABCP rules (2103). For the ABCP general rule creation (2101), an ABCP organizer may select a promotion period, an eligibility scope (e.g. age, residency, affiliation exclusion), a total award size, an award partition, limiting parameters related to participating sponsors, and required or optional entrant attributes. The ABCP general rule creation procedure (2101) as shown in FIG. 21 can serve as a general guideline for a plurality of particular ABCP campaigns. In contrast, a predefined ABCP rule creation (2103) may be more specific to a particular ABCP campaign and may incorporate game-specific, contest-specific, or sweepstakes-specific regulations for potential prize winners from a pool of entrants For the predefined ABCP rule creation (2103), an ABCP organizer may create a predefined promotion period rule, a predefined entrant eligibility rule, a predefined award (e.g. type, size, prize disbursement method, and etc.), and a predefined winner selection rule.

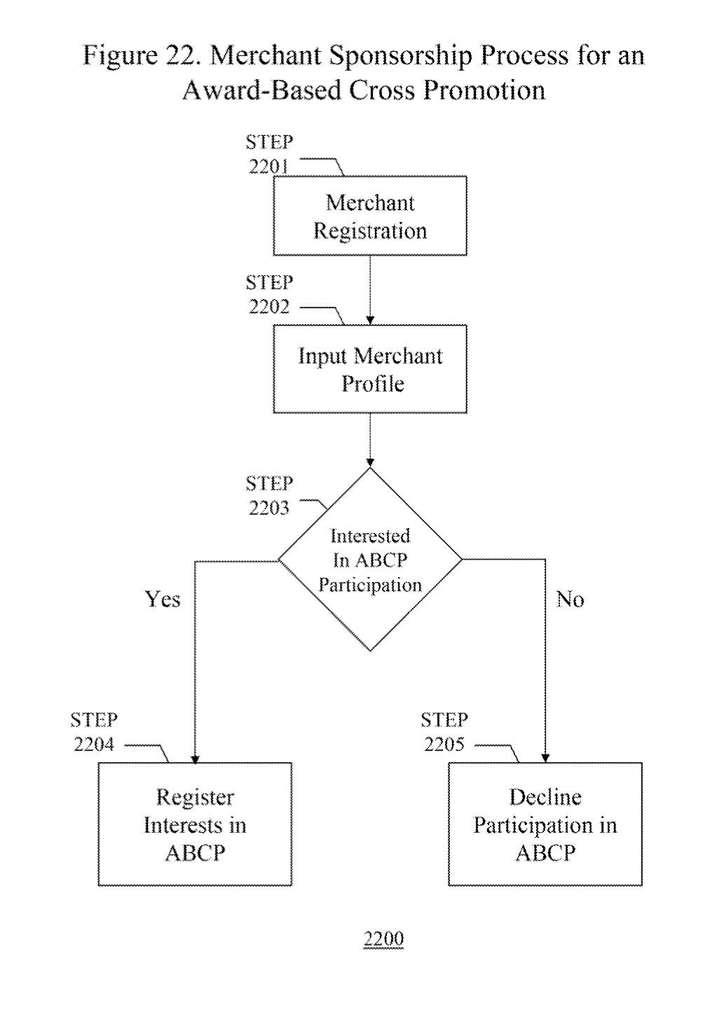

FIG. 22 illustrates a merchant sponsorship process for an award-based cross promotion. After the rule generation is created, the organizer can then invite potential sponsors to join to participate in the ABCP after a merchant registration process (STEP 2201) and formulating an input merchant profile (STEP 2202). The invitation can be sent through the system, of which the organizer inputs the contact information such as an email address of the invited. The email can contain an URL which directs the invited sponsor to the ABCP management system when clicked. Each link can contain an identification code which uniquely identifies the invited sponsor by its email address.

When the invited sponsor clicks on the link, the invited sponsor will be able to see the details of the ABCP and also asked whether the invited sponsor is interested in an ABCP participation (STEP 2203). If the invited sponsor feels comfortable with the specified ABCP, the invited sponsor can join the ABCP (STEP 2204), indicating their contribution portion to the award. If the invited sponsor feels that the ABCP needs to be modified, the invited sponsor can send a message to the organizer through the system to express such concerns and suggestions, or through an offline method of communication. The organizer can determine whether to modify the ABCP or not. The invited merchant can also choose to decline the invitation (STEP 2205).

In one embodiment of the invention, if the organizer modifies terms of the ABCP, all invited and participated merchants will be notified. Once the organizer feels comfortable that an ABCP is ready, the organizer can lock the ABCP, preventing further sponsor participation and changes on the ABCP. Selected sponsors will be notified, and will be asked to fund the portion of the award they are responsible for. In one embodiment of the invention, the funding for a joint funding pool may be a monetary funding pool in which sponsor entities contribute certain amount of money to the joint funding pool. In another embodiment of the invention, the funding for the joint funding pool may be based on vouchers, coupons, or another valuable asset which are contributed to the joint funding pool. Yet in another embodiment of the invention, the funding for the joint funding pool may be based on a combination of money, vouchers, coupons, or another valuable asset which are contributed to the joint funding pool. When funding from all participating sponsors is complete, the ABCP will become available to the public, so interested entrants can search and participate in the ABCP.

An entrant may become aware of an ABCP through the participating sponsors, a word-of-mouth marketing, an URL directly linking to the ABCP entry, or a search for all available ABCP's on the system. Once an ABCP is identified, the entrant can enter the ABCP according to the rules and qualification process associated with the ABCP.

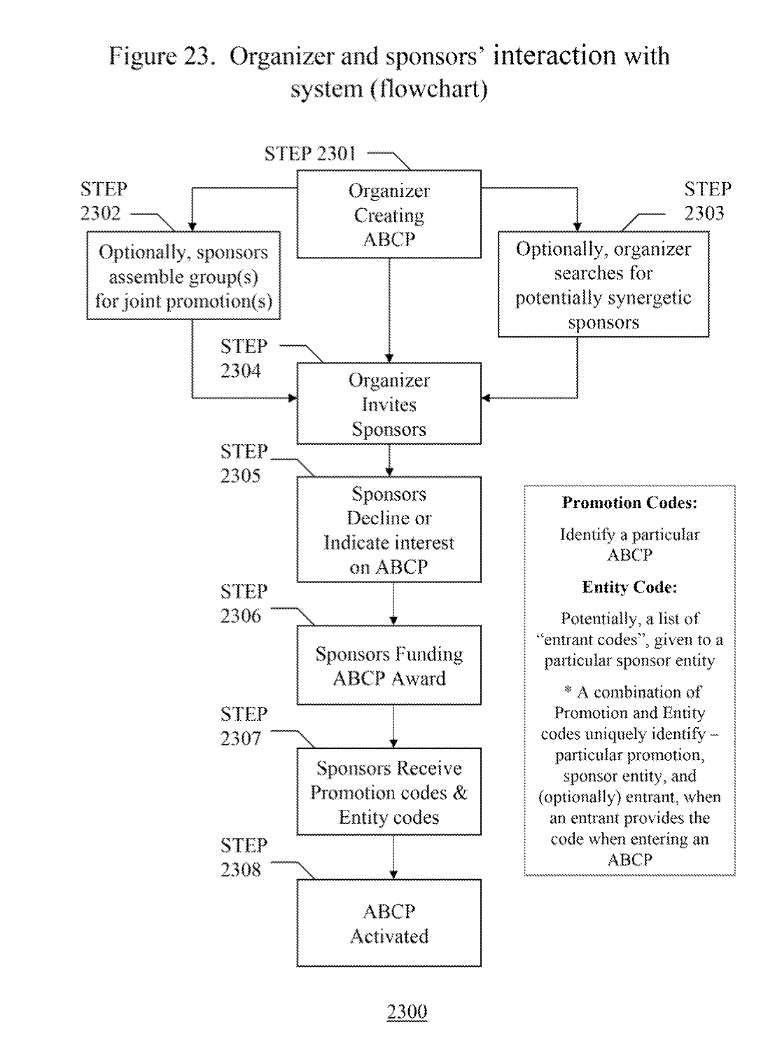

FIG. 23 shows a flowchart (2300) for organizer and sponsor's interaction with an ABCP management system, in accordance with an embodiment of the invention. In this particular example, the organizer first creates an ABCP (STEP 2301) and optionally searches for potentially synergetic sponsors (STEP 2303). Furthermore, sponsors can also assemble groups for joint promotions (STEP 2302) at their discretion. Then, the organizer invites sponsors to the particular ABCP, which may involve an email invitation containing a hyperlink for each sponsor, or another communication method (STEP 2304). Sponsors then either accept or decline interest on the particular ABCP offered by the organizer (STEP 2305). Then, the sponsors interested in the particular ABCP can jointly fund for the ABCP award (STEP 2306), and receive promotion codes and entity codes from the ABCP management system (STEP 2307). In a preferred embodiment of the invention, most, if not all, of the above-mentioned steps (STEPS 2301˜2307) are required for a formal activation (STEP 2308) of an ABCP for entrants' subsequent involvement in the ABCP.

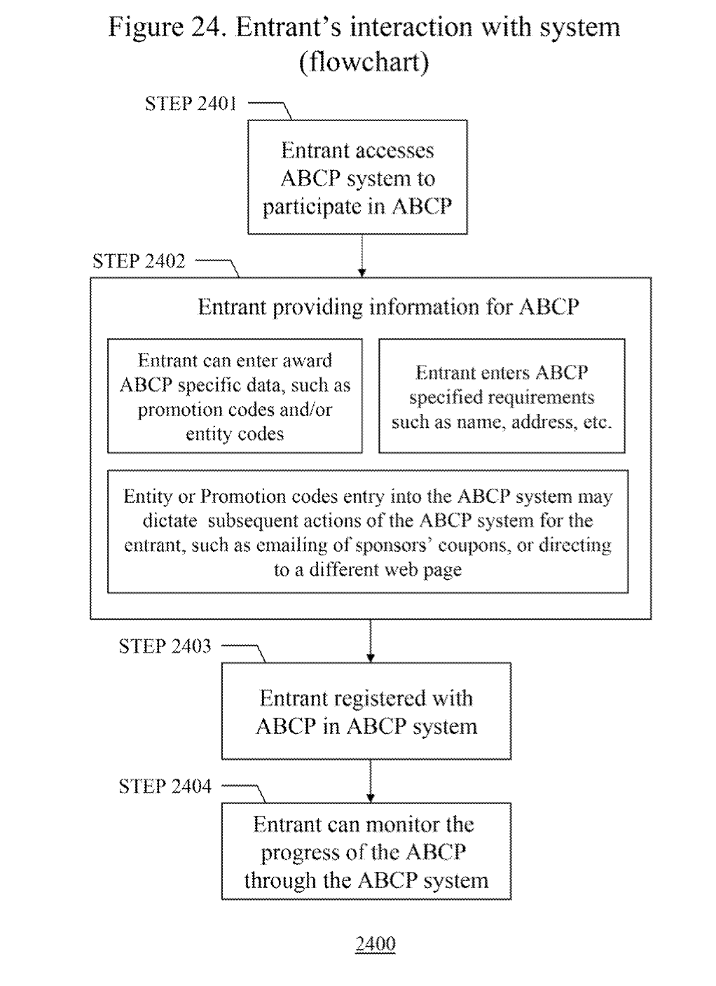

FIG. 24 shows a flowchart (2400) for an entrant's (e.g. a qualified customer's) interaction with an ABCP management system, in accordance with an embodiment of the invention. In this example, the entrant first accesses the ABCP system to participate in a particular ABCP (STEP 2401). Then, the entrant can provide information to the particular ABCP (STEP 2402). Examples of the entrant's data entry include, but are not limited to, entering award-specific or ABCP-specific data such as promotion codes and/or entity codes. The entrant may also enter ABCP-specified requirements such as name, address, and etc. Entity or promotion codes entry into the ABCP system may dictate subsequent actions of the ABCP system for the entrant, such as emailing of sponsors' coupons, or directing to a different web page. When the entrant completes his/her data entry into the ABCP system, the entrant is registered with the particular ABCP in the ABCP system (STEP 2403). Then, the entrant can monitor the progress of the particular ABCP through the ABCP system (STEP 2404).

Some rules may require entrants to provide only contact information; some may require entrant to solve a puzzle, provide answer to a question, and etc.; some rules may dictate that entrants need to enter the validation code for each sponsor, thus ensuring the entrant had interacted with the sponsor; and some may direct an entrain to an interface in which only one merchant is identified in a round robin way, so each sponsor gets the chance to be presented to an entrant. Once an entrant submits the information to the system, the system can store the submitted data. Using the data, the system can determine whether the information provided is sufficient to meet the eligibility of the ABCP participation according to the defined eligibility and winner selection rule of the ABCP. In the case of a contest rather than a game of chance, the rule engine will determine whether entrant qualifies for the contest and determines the ranking of the entrant in the ABCP.

The eligibility status can be provided to an entrant and gives the necessary feedback for the entrant to pursue actions to achieve eligibility status. The system can also periodically provide reports of the ABCP to entrants, allowing the entrants to tune their efforts to achieve a higher chance of winning the award (e.g. in a customer loyalty program, the award may be given to the entrant with most purchases from the participating sponsors).

When the ABCP period ends, the system can automatically select a winner from the eligible entrants according to the rules of the ABCP. The winner selection can also happen offline, and the result being input to the system. Once one or more winners are determined, the one or more winner will be notified through the contact information already associated with entrants in the system. The system can also notify all participated entrants to let them know of the results, and invite them to join another set of ABCPs matching their profile.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An award-based cross promotion (ABCP) management system, the system comprising:
a group of program modules executable on a server machine containing a memory unit and a microprocessor or microcontroller, wherein the group of program modules comprises an organizer module, a merchant module, an entrant module, an award-based cross promotion (ABCP) management module, a communication module, and a payment module;
a merchant computer operatively connected to the group of program module's;
an organizer computer operatively connected to the group of program modules; and
an entrant computer operatively connected to the group of program modules.

2. The award-based cross promotion management system of claim 1, wherein the group of program modules further includes a mapping engine.

3. The award-based cross promotion management system of claim 1, further comprising a database system for storing information related to an award-specific rule, and a network which operatively connects the group of program modules to the merchant computer, the organizer computer, and/or the entrant computer.

4. The award-based cross promotion management system of claim 1, further comprising a load balancer to regulate an amount of connection or network traffic to the server machine in order to prevent system latch-up caused by a surge in connection requests, network traffic, and/or a potential denial-of-service (DOS) attack to the server machine.

5. The award-based cross promotion management system of claim 1, wherein the organizer module comprises an ABCP creation and modification controller, a sponsors invitation controller, and a sponsors approval controller.

6. The award-based cross promotion management system of claim 1, wherein the merchant module comprises an ABCP sponsorship controller and a merchant registration controller.

7. The award-based cross promotion management system of claim 1, wherein the entrant module comprises an entrant registration controller.

8. The award-based cross promotion management system of claim 1, wherein the ABCP management module comprises an ABCP construction module, an ABCP activation module, an ABCP entrant interaction module, an ABCP monitoring module, an ABCP prize fulfillment module, an ABCP sponsor code generation module, and an ABCP state machine controller.

9. The award-based cross promotion management system of claim 1, wherein the communication module comprises a social site gateway controller, an email gateway controller, and an SMS gateway controller.

10. The award-based cross promotion management system of claim 1, wherein the payment module comprises a fee calculator and a payment gateway controller.

11. The award-based cross promotion management system of claim 2, wherein the mapping engine comprises an inspection module, a matching module, and a recommendation engine, wherein the mapping engine is configured to generate a potential partnership matching status.

12. The award-based cross promotion management system of claim 11, wherein the mapping engine utilizes category matching, geographic proximity matching, numeric matching, keyword tag matching, K-nearest neighbor algorithm (k-NN), collaborative filtering, singular value decomposition, or a combination thereof.

13. The award-based cross promotion management system of claim 1, wherein at least one of the merchant computer, the organizer computer, and the entrant computer is a desktop computer, a laptop computer, or a mobile computing and communication device.

14. A method of activating an award-based cross promotion (ABCP) campaign from an ABCP management system, the method comprising:
creating an award-based cross promotion (ABCP) campaign based on an award-based cross promotion general rule creation, predefined ABCP rules, and an ABCP template;
inviting one or more sponsors to participate in the ABCP campaign via email invitations or other communication methods;
receiving each of the one or more sponsors' consent or declination to participate in the ABCP campaign;
allowing participating sponsors who consented to participating in the ABCP campaign to jointly fund the ABCP campaign, wherein the ABCP campaign is funded by money, vouchers, coupons, another valuable asset, or a combination thereof; and
enabling the ABCP campaign for active service for entrants to participate in the ABCP campaign.

15. The method of claim 14, further comprising the steps of sending promotion codes and/or entity codes to each participating sponsor.

16. The method of claim 14, further comprising the steps of
allowing the entrants to enroll in the ABCP campaign after the ABCP campaign is activated;
changing status of the ABCP campaign when an enrollment status changes; and
deciding one or more winners in the ABCP campaign and distributing prizes to the one or more winners.

17. The method of claim 14, wherein the participating sponsors may be merchants, business entities, or non-profit entities.

18. The method of claim 15, wherein the promotion codes and entity codes sent to each participating sponsor can be used to identify a particular ABCP campaign, a particular, participating sponsor, a particular action defined by a particular sponsor, and an entrant into the particular ABCP campaign.

19. The method of claim 14, wherein the step of creating an award-based cross promotion (ABCP) campaign further comprises a step of matching or recommending potentially synergetic sponsors by inspecting, comparing, and analyzing profile attributes of a sponsor entity to be matched and desired partner attributes of a plurality of potential partners.

20. The method of claim 19, wherein the step of matching or recommending potentially synergetic sponsors utilizes a category matching, a geographic proximity matching, a numeric matching, a keyword or tag matching, a k-NN algorithm, a collaborative filtering, and/or a singular value decomposition technique.
